(19) United States
(12) Patent Application Publication
(10) Pub. No.: US 2021/0291982 A1
(43) Pub. Date: Sep. 23, 2021

(54) METHOD AND SYSTEM FOR CONTROLLING MOVEMENT OF MOVABLE DEVICES

(71) Applicant: SZ DJI TECHNOLOGY CO., LTD., Shenzhen (CN)

(72) Inventors: Minzhe TAN, Shenzhen (CN); Kai WANG, Shenzhen (CN); Canlong LIN, Shenzhen (CN)

(21) Appl. No.: 17/339,827

(22) Filed: Jun. 4, 2021

Related U.S. Application Data
(63) Continuation of application No. PCT/CN2018/119168, filed on Dec. 4, 2018.

(51) Int. Cl. B64C 39/02; G05D 1/10; G05D 1/00

(52) U.S. Cl. CPC B64C 39/024; G05D 1/104; B64C 2201/146; G05D 1/1064; G05D 1/0011

(57) ABSTRACT

A method of controlling movement of a plurality of movable devices includes determining, by a processor, at least one of a first priority level or a first safety zone for a first movable device of the plurality of movable devices. The method also includes determining, by the processor, at least one of a second priority level or a second safety zone for a second movable device of the plurality of movable devices based on information relating to the second movable device. The method further includes generating, by the processor, a collision avoidance measure to avoid collision with the second movable device during movement based on at least one of the first priority level, the first safety zone, the second priority level, or the second safety zone.

### CROSS-REFERENCE TO RELATED APPLICATION

This application is a continuation of International Application No. PCT/CN2018/119168, filed Dec. 4, 2018, the entire content of which is incorporated herein by reference.

### TECHNICAL FIELD

The present disclosure relates to the technology field of movable devices and, more particularly, to method and system for controlling movement of movable devices.

### BACKGROUND

Aerial vehicles, such as unmanned aerial vehicles (UAVs), have been developed for a wide range of applications. In certain scenarios, a group of UAVs or a network of UAVs may be deployed to work collaboratively and/or independently. A group of UAVs may be controlled by one or more remote controllers or one or more communication base stations to fly over a geographical region to perform different tasks simultaneously and/or collaboratively, or to perform different parts of a same task simultaneously and/or collaboratively. For example, a group of UAVs may be deployed during a celebration or sport event to perform various actions in the air for entertainment purposes (e.g., to display certain words), for surveillance purposes (e.g., to monitor traffic), for photographing purposes (e.g., to capture images of the event from different perspectives), for public safety purposes (e.g., to monitor and detect safety issues), etc.

Controlling multiple UAVs flying over the same geographical region simultaneously can be challenging. With multiple UAVs (e.g., hundreds of UAVs) carrying out different tasks (or different parts of a same task), the chance for the flight paths of the multiple UAVs to cross one another is high. Therefore, there is a high risk of collision if a proper collision avoidance measure is not taken. In the current consumer level and professional level UAV market, due to the limit on the load and manufacturing cost, very few, if any, UAVs are equipped with an autonomous collision avoidance functions. Consumer airlines have used autonomous collision avoidance systems. However, such systems are too costly and bulky for small UAVs for civil applications, particularly for light-weight UAVs that can carry only limited amount of load.

Accordingly, there is a need to develop effective methods and systems for controlling multiple aerial vehicles simultaneously and/or collaboratively to avoid collision.

### SUMMARY

An embodiment of the present disclosure provides a method of controlling movement of a plurality of movable devices. The method includes determining, by a processor, at least one of a first priority level or a first safety zone for a first movable device of the plurality of movable devices. The method also includes determining, by the processor, at least one of a second priority level or a second safety zone for a second movable device of the plurality of movable devices based on information relating to the second movable device. The method further includes generating, by the processor, a collision avoidance measure to avoid collision with the second movable device during movement based on at least one of the first priority level, the first safety zone, the second priority level, or the second safety zone.

An embodiment of the present disclosure provides a method of controlling movement of a plurality of movable devices. The method includes determining, by a server, at least one of a first priority level or a first safety zone for a first movable device of the plurality of movable devices based on first information relating to the first movable device. The method also includes determining, by the server, at least one of a second priority level or a second safety zone for a second movable device of the plurality of movable devices based on second information relating to the second movable device. The method also includes generating, by the server, a collision avoidance measure to avoid collision between the first movable device and the second movable device during movement based on at least one of the first priority level, the first safety zone, the second priority level, or the second safety zone. The method further includes transmitting, by the server, the collision avoidance measure to at least one of the first movable device or the second movable device to enable the at least one of the first movable device or the second movable device to avoid collision with one another based on the collision avoidance measure.

An embodiment of the present disclosure provides a system. The system includes a plurality of movable devices movable in an environment. A first movable device of the plurality of movable devices includes a memory configured to store instructions and a processor configured to access the memory and execute the instructions to determine at least one of a first priority level or a first safety zone for a first movable device of the plurality of movable devices. The processor is also configured to access the memory and execute the instructions to determine at least one of a second priority level or a second safety zone for a second movable device of the plurality of movable devices based on information relating to the second movable device. The processor is further configured to access the memory and execute the instructions to generate a collision avoidance measure to avoid collision with the second movable device during movement based on at least one of the first priority level, the first safety zone, the second priority level, or the second safety zone.

An embodiment of the present disclosure provides a server. The server includes a memory configured to store instructions. The server also includes a processor configured to access the memory and execute the instructions to determine at least one of a first priority level or a first safety zone for a first movable device of the plurality of movable devices based on first information relating to the first movable device. The processor is also configured to access the memory and execute the instructions to determine at least one of a second priority level or a second safety zone for a second movable device of the plurality of movable devices based on second information relating to the second movable device. The processor is also configured to access the memory and execute the instructions to generate a collision avoidance measure to avoid collision between the first movable device and the second movable device during movement based on at least one of the first priority level, the first safety zone, the second priority level, or the second safety zone. The server further includes a transceiver configured to transmit the collision avoidance measure to at least one of the first movable device or the second movable device to enable the at least one of the first movable device or the second movable device to avoid collision with one another based on the collision avoidance measure.

An embodiment of the present disclosure provides a movable device. The movable device includes a memory configured to store instructions. The movable device also includes a processor configured to access the memory and execute the instructions to determine at least one of a first priority level or a first safety zone for a first movable device of a plurality of movable devices. The processor is also configured to access the memory and execute the instructions to determine at least one of a second priority level or a second safety zone for a second movable device of the plurality of movable devices based on information relating to the second movable device. The processor is further configured to access the memory and execute the instructions to generate a collision avoidance measure to avoid collision with the second movable device during movement based on at least one of the first priority level, the first safety zone, the second priority level, or the second safety zone.

An embodiment of the present disclosure provides an unmanned aerial vehicle. The unmanned aerial vehicle includes a body and at least one propulsion assembly mounted to the body and configured to provide a propulsion force. The unmanned aerial vehicle further includes a controller configured to determine at least one of a first priority level or a first safety zone for a first unmanned aerial vehicle of the plurality of unmanned aerial vehicles. The controller is also configured to determine at least one of a second priority level or a second safety zone for a second unmanned aerial vehicle of the plurality of unmanned aerial vehicles based on information relating to the second unmanned aerial vehicle. The controller is further configured to generate a collision avoidance measure to avoid collision with the second unmanned aerial vehicle during movement based on at least one of the first priority level, the first safety zone, the second priority level, or the second safety zone.

Embodiments of the present disclosure address the collision avoidance issues encountered by a system having multiple movable devices that move simultaneously (e.g., multiple UAVs that fly in the same space simultaneously). According to the present disclosure, priority levels of the UAVs may be determined. The movable devices having higher priority levels may be allowed to pass a potential crossing point of travel paths before movable devices having lower priority levels. Movable devices having lower priority levels may autonomously take collision avoidance measures to avoid collision with the movable devices having higher priority levels. For example, the movable devices having lower priority levels may autonomously reduce their speeds to avoid collision with movable devices having higher priority levels. Thus, when there are crossing points in their travel paths, the movable devices can orderly and efficiently pass the crossing points without having a collision. The priority levels may be determined based on the information shared by the UAVs. The amount of information shared by the UAVs may include the location information and certain status information that may not take up a large communication bandwidth. In addition, the computational cost for calculating the priority levels and safety zones of the UAVs may be effectively controlled because the computation may be distributed to the UAVs, the remote control devices, and/or one or more servers. Thus, the communication pressure and cost of the disclosed system may be reduced. The disclosed methods and systems may be effectively applied to control simultaneous movement of a large number of movable devices, such as a large number of UAVs.

It shall be understood that different aspects of the present disclosure can be appreciated individually, collectively, or in combination with each other. Various aspects of the present disclosure described herein may be applied to any of the particular applications set forth below or for any other types of movable devices. Any description herein of aerial vehicles, such as unmanned aerial vehicles, may apply to and be used for any movable device, such as any vehicle. Additionally, the systems, devices, and methods disclosed herein in the context of aerial motion (e.g., flight) may also be applied in the context of other types of motion, such as movement on the ground or on water, underwater motion, or motion in space.

Other objects and features of the present disclosure will become apparent by a review of the specification, claims, and appended figures.

### BRIEF DESCRIPTION OF THE DRAWINGS

The novel features of the present disclosure are set forth with particularity in the appended claims. A better understanding of the features and advantages of the present disclosure will be obtained by referencing to the following detailed description that sets forth illustrative embodiments, in which the principles of the present disclosure are utilized, and the accompanying drawings of which:

FIG. 1 is a schematic diagram of a system including a plurality of movable devices, in accordance with an embodiment of the present disclosure.

FIG. 2 is a schematic diagram of a system including a plurality of movable devices, in accordance with another embodiment of the present disclosure.

FIG. 3 is a schematic diagram of a movable device, in accordance with an embodiment of the present disclosure.

FIG. 4 is a schematic diagram of a flight control device, in accordance with an embodiment of the present disclosure.

FIG. 5 is a schematic diagram of a server, in accordance with an embodiment of the present disclosure.

FIG. 6 is a schematic diagram of a remote control device or a base station, in accordance with an embodiment of the present disclosure.

FIG. 7(A) is a schematic illustration of a safety zone, in accordance with an embodiment of the present disclosure.

FIG. 7(B) is a schematic illustration of a horizontal plane projection of the safety zone, in accordance with an embodiment of the present disclosure.

FIG. 7(C) is a schematic illustration of a vertical plane projection of the safety zone, in accordance with an embodiment of the present disclosure.

FIG. 8 is a schematic illustration of a vertical collision avoidance measure, in accordance with an embodiment of the present disclosure.

FIG. 9 is a schematic illustration of a vertical layer separation scheme, in accordance with an embodiment of the present disclosure.

FIG. 10 is a schematic illustration of an example of a horizontal collision avoidance measure, in accordance with an embodiment of the present disclosure.

FIG. 11 is a schematic illustration of another example of a horizontal collision avoidance measure, in accordance with an embodiment of the present disclosure.

FIG. 12(A) is a schematic illustration of safety zones calculated by a first movable device, in accordance with an embodiment of the present disclosure.

FIG. 12(B) is a schematic illustration of safety zones calculated by a second movable device, in accordance with an embodiment of the present disclosure.

FIG. 12(C) is a schematic illustration of safety zones calculated by a third movable device, in accordance with an embodiment of the present disclosure.

FIG. 13(A) is a schematic illustration of a scenario in which projected flight paths of two UAVs have a crossing point, in accordance with an embodiment of the present disclosure.

FIG. 13(B) is a schematic illustration of a collision avoidance measure based on priority levels and/or safety zones, in accordance with an embodiment of the present disclosure.

FIG. 13(C) is a schematic illustration of a collision avoidance measure based on priority levels and/or safety zones, in accordance with an embodiment of the present disclosure.

FIG. 13(D) is a schematic illustration of a collision avoidance measure based on priority levels and/or safety zones, in accordance with an embodiment of the present disclosure.

FIG. 13(E) is a schematic illustration of a collision avoidance measure based on safety zones, in accordance with an embodiment of the present disclosure.

FIG. 13(F) is a schematic illustration of movement of two UAVs after passing the crossing point, in accordance with an embodiment of the present disclosure.

FIG. 14 is a flow chart illustrating a method for controlling movement of movable devices, in accordance with an embodiment of the present disclosure.

FIG. 15 is a flow chart illustrating a method for controlling movement of movable devices, in accordance with another embodiment of the present disclosure.

FIG. 16 is a flow chart illustrating a method for controlling movement of movable devices, in accordance with another embodiment of the present disclosure.

FIG. 17 is a flow chart illustrating a method for controlling movement of movable devices, in accordance with another embodiment of the present disclosure.

FIG. 18 is a flow chart illustrating a method for controlling movement of movable devices, in accordance with another embodiment of the present disclosure.

FIG. 19 is a flow chart illustrating a method for controlling movement of movable devices, in accordance with another embodiment of the present disclosure.

### DETAILED DESCRIPTION

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

Example embodiments will be described with reference to the accompanying drawings, in which the same numbers refer to the same or similar elements unless otherwise specified.

As used herein, when a first component (or unit, element, member, part, piece) is referred to as “coupled,” “mounted,” “fixed,” “secured” to or with a second component, it is intended that the first component may be directly coupled, mounted, fixed, or secured to or with the second component, or may be indirectly coupled, mounted, or fixed to or with the second component via another intermediate component. The terms “coupled,” “mounted,” “fixed,” and “secured” do not necessarily imply that a first component is permanently coupled with a second component. The first component may be detachably coupled with the second component when these terms are used. When a first component is referred to as “connected” to or with a second component, it is intended that the first component may be directly connected to or with the second component or may be indirectly connected to or with the second component via an intermediate component. The connection may include mechanical and/or electrical connections. The connection may be permanent or detachable. The electrical connection may be wired or wireless. When a first component is referred to as “disposed,” “located,” or “provided” on a second component, the first component may be directly disposed, located, or provided on the second component or may be indirectly disposed, located, or provided on the second component via an intermediate component. When a first component is referred to as “disposed,” “located,” or “provided” in a second component, the first component may be partially or entirely disposed, located, or provided in, inside, or within the second component. The terms “perpendicular,” “horizontal,” “left,” “right,” “up,” “upward,” “upwardly,” “down,” “downward,” “downwardly,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

The term “communicatively coupled” indicates that related items are coupled through a communication channel, such as a wired or wireless communication channel.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

The following descriptions explain example embodiments of the present disclosure, with reference to the accompanying drawings. Unless otherwise noted as having an obvious conflict, the embodiments or features included in various embodiments may be combined.

The following embodiments do not limit the sequence of execution of the steps included in the disclosed methods. The sequence of the steps may be any suitable sequence, and certain steps may be repeated.

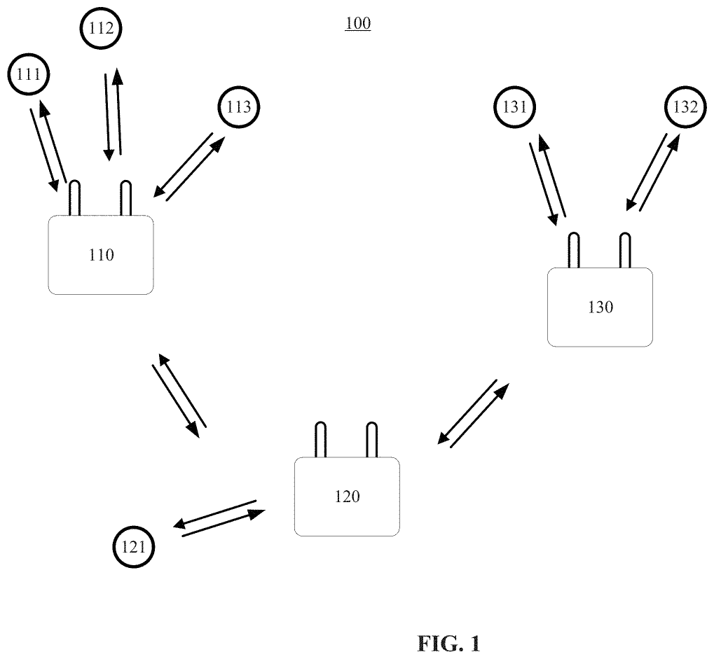

FIG. 1 is a schematic diagram of a system 100 including a plurality of movable devices 111, 112, 113, 121, 131, and 132, which are movable in an environment. The movable devices may include any suitable devices that can move in an environment. For example, a movable device may be an aircraft such as an unmanned aerial vehicle (“UAV”). The movable device may also be a robot, ground vehicle, a water surface vehicle, an underwater vehicle, a satellite, a flying object, etc. For the convenience of illustration and understanding of the disclosed technology, UAVs are used as example movable devices in the following discussions. Thus, movable devices 111, 112, 121, 131, and 132 shown in FIG. 1 may also be referred to as UAVs 111, 112, 121, 131, and 132 for discussion and illustration purposes.

As shown in FIG. 1, the system 100 may include one or more remote control devices, such as a first remote control device 110, a second remote control device 120, and a third remote control device 130. The remote control devices 110, 120, and 130 may be handheld remote control devices, ground terminals equipped with computers and/or controllers that can remotely control the UAVs, smart phones installed with remote control applications for remotely controlling the UAVs, or communication base stations, such as a cellular telecommunication base station, a router, a relay, etc. The remote control device of the present disclosure may include any type of controller that can remotely control a UAV. The remote control devices 110, 120, and 130 may be of the same type (e.g., all being handheld remote control devices), or may be a mixture of different types (e.g., some may be handheld remote control devices, some may be ground terminals, etc.).

Each of the remote control devices 110, 120, and 130 (or base stations) may be communicatively coupled with one or more UAVs and may be configured to control the one or more UAVs. Each of the remote control devices 110, 120, and 130 may be communicatively coupled with and configured or programmed to receive data or signals from the one or more UAVs 111, 112, 113, 121, 131, and 132. Each of the remote control devices 110, 120, and 130 may be configured to transmit data (e.g., control signals or command) to the one or more UAVs for controlling the movement (e.g., flight) of the UAVs. For example, UAVs 111, 112, and 113 may exchange data or signals with the first remote control device 110. The first remote control device 110 may control the flight of the UAVs 111, 112, and 113 by transmitting control signals to the UAVs. UAV 121 may exchange data or signals with the second remote control device 120. The second remote control device 120 may control the flight of UAV 121 by transmitting control signals to UAV 121. UAVs 131 and 132 may exchange data or signals with the third remote control device 130. The third remote control device 130 may control the flight of UAVs 131 and 132 by transmitting control signals to the UAVs.

The communication channels between a UAV and a remote control device, and between the remote control devices may implement any suitable communication techniques. For example, the communication may use any suitable wireless communication techniques, such as Wi-Fi communication (e.g., 2.4 GHz communication, 5.8 GHz communication), cellular communication (e.g., 3G, 4G, or 5G telecommunication), infrared communication, etc. In some embodiments, the communication among the remote control devices may also use wired communication through cables, wires, etc.

The remote control devices 110, 120, and 130 may be communicatively coupled with each other, and may exchange data with each other. For example, the first remote control device 110 may be communicatively coupled with the second remote control device 120, and the second remote control device 120 may be communicatively coupled with the third remote control device 130. In some embodiments, the first remote control device 110 may be communicatively coupled with the third remote control device 130 directly.

In some embodiments, the UAVs may share information with their respective remote control devices communicatively coupled with the UAVs. A remote control device may share the information received from one or more UAVs with one or more other remote control devices. In other words, the UAVs may share information among them through the remote control devices. In some embodiments, the UAVs may share information through base stations of telecommunication networks, such as a 3G, 4G, or 5G cellular network, rather than through the remote control devices. The information shared by the UAVs may include at least one of a location, a flight speed, a flight height, a flight direction, an attitude, a task, a quality of signal, an identification, a type of UAV, or a time when a connection is first established with a remote control device.

Information relating to the location of the UAV may be determined using positioning sensors provided on the UAV, such as a global positioning system (“GPS”) sensor, a real-time kinematic sensor, a visual-inertial odometry sensor, etc. In some embodiments, the location information may also be determined by telecommunication cellular base stations communicatively coupled with the UAV. In some embodiments, the location information may also be determined by a remote control device communicatively coupled with the UAV. In some embodiments, the location information may be represented by coordinates in a predetermined coordinate system, or by a combination of altitude, latitude, and height.

Information relating to the attitude may include at least one of a pitch angle, a roll angle, or a yaw angle of a UAV. Information relating to the task may include a type of the task, an execution status or progress of the task, an urgency level of the task, an importance level of the task. For example, the task may be related to fire and rescue, agriculture, photographing, entertainment, surveillance, policing, etc., each of which may be assigned with an urgency level or an importance level. As another example, the task may be providing a control role for other UAVs, providing a signal relay function for other UAVs, etc.

The information relating to the quality of signal may indicate the quality of communication between the UAV and the corresponding remote control device. The quality of signal may be poor, good, excellent, or may be quantified using numerical values. The information relating to the identification of the UAV may refer to an identification number or code that can uniquely identify a UAV. For example, each UAV may have a serial number that may be unique.

The type of UAV may refer to a size of the UAV (e.g., large, medium, small, micro), or the utility of the UAV, such as a photographing UAV, a fire and rescue UAV, a public safety or security surveillance UAV, a traffic surveillance UAV, a police UAV, a military UAV, an agriculture UAV, an entertainment UAV, a consumer level UAV, a professional level UAV, a communication UAV, etc. The type of UAV may also refer to the number of axes, such as a three-axis UAV, a four-axis UAV, a six-axis UAV, an eight-axis UAV, etc.

The time when a connection is first established with a remote control device may refer to the time when a UAV first joined the system 100 by establishing a connection with a remote control device. For example, the UAVs may join the system 100 by establishing a communication with one or more remote control devices included in the system 100 using a predetermined communication protocol. The UAVs may not be of the same type or be made by the same manufacturer. As long as the UAVs can communicate with a remote control device included in the system 100 using the predetermined communication protocol, the UAVs may join the system 100. The time may be, for example, 08:30 a.m. on Nov. 6, 2018. Thus, when the UAVs join the system 100 at different, unique times, the times associated with the UAVs may uniquely identify the UAVs, or may be used to calculate unique priority levels associated with the UAVs.

In some embodiments, UAVs 111, 112, and 113 may share information with the first remote control device 110 by transmitting the information relating to UAVs 111, 112, and 113 to the first remote control device 110. The first remote control device 110 may share the information received from UAVs 111, 112, and 113 with one or more other remote control devices. For example, the first remote control device 110 may share the information received from UAVs 111, 112, and 113 with the second remote control device 120. In some embodiments, the first remote control device 110 may share the information received from UAVs 111, 112, and 113 with the third remote control device 130.

In some embodiments, when any one of UAVs 111, 112, and 113, for example, UAV 111, shares its information with the first remote control device 110, the first remote control device 110 may share the information relating to UAV 111 with one or both of UAVs 112 and 113. One or both of UAVs 112 and 113 may receive the information relating to UAV 111 from the first remote control device 110. In some embodiments, the first remote control device 110 may share the information relating to UAV 111 with one or both of the second remote control device 120 and the third remote control device 130 (and further to all of the UAVs connected with the remote control devices 120 and 130). In some embodiments, the first remote control device 110 may share the information received from UAV 111 with all of the UAVs included in the system 100 directly or indirectly through other remote control devices, regardless of the distances from the UAVs to UAV 111. In some embodiments, the first remote control device 110 may share the information received from UAV 111 with only the UAVs that are located within a predetermined distance from UAV 111. For example, the first remote control device 110 may share the information received from UAV 111 only with UAVs 112 and 113, which may be located within a predetermined distance (e.g., 10 meters) from UAV 111, and to which UAV 111 may pose a risk of collision. UAV 111 may not pose a risk of collision to UAVs located more than the predetermined distance from UAV 111, and hence the first remote control device 110 may not share the information received from UAV 111 with those UAVs. In some embodiments, the first remote control device 110 may share, with UAV 111, information relating to other UAVs that are located within a predetermined distance from UAV 111. For example, UAV 111 may receive, from the first remote control device 110, information relating to other UAVs that are located within a predetermined distance from UAV 111.

In some embodiments, the first remote control device 110 may share the information received from UAV 111 with another remote control device that is located within a predetermined distance from the first remote control device 110. For example, when the second remote control device 120 is located within a predetermined distance from the first remote control device 110, the first remote control device 110 may share information received from UAV 111, UAV 112, or UAV 113 with the second remote control device 120. When the second remote control device 120 is located more than the predetermined distance from the first remote control device 110, the first remote control device 110 may not share the information received from any of UAVs 111, 112, and 113 with the second remote control device 120.

The second remote control device 120 may share the information relating to UAVs 111, 112, and 113 received from the first remote control device 110 with UAV 121 and/or the third remote control device 130, each of which is communicatively coupled with the second remote control device 120. UAV 121 may share information with the second remote control device 120. The second remote control device 120 may share the information received from UAV 121 with the first remote control device 110 and/or the third remote control device 130. The first remote control device 110 may further share the information relating to UAV 121 with UAVs 111, 112, and 113. The third remote control device 130 may share the information relating to UAV 121 with UAVs 131 and 132. By sharing the information, each UAV included in the system 100 may receive information of another UAV periodically. The periodicity may be suitably set such that the information sharing may be in real time or near real time. Each UAV may calculate a priority level and/or a safety zone of another UAV based on the information instantly shared by the other UAV.

In some embodiments, the information may be shared periodically (e.g., in real-time or near real-time) by a UAV with a remote control device or a communication base station using a pulse signal at, for example, 10 Hz or more. Other suitable signals and/or frequencies may also be used. In some embodiments, the UAV may assemble the information into a data packet, and may transmit the data packet to the remote control device. The remote control device may transmit the data packet to other UAVs or other remote control devices connected with the remote control device. The other remote control devices may further share the information with one or more other UAVs connected with the other remote control devices.

The third remote control device 130 may receive information from one of UAVs 131 and 132 (e.g., UAV 131). The third remote control device 130 may share the information received from UAV 131 with UAV 132. In some embodiments, the third remote control device 130 may share the information received from UAV 131 with one or both of the first remote control device 110 and the second remote control device 120. The first remote control device 110 may share the information relating to UAV 131 with one or more of UAVs 111, 112, and 113 connected to the first remote control device 110. The second remote control device 120 may share the information relating to UAV 131 with UAV 121 connected to the second remote control device 120. In some embodiments, when the third remote control device 130 shares the information relating to UAV 131 with only the second remote control device 120, the second remote control device 120 may further share the information relating to UAV 131 with the first remote control device 110.

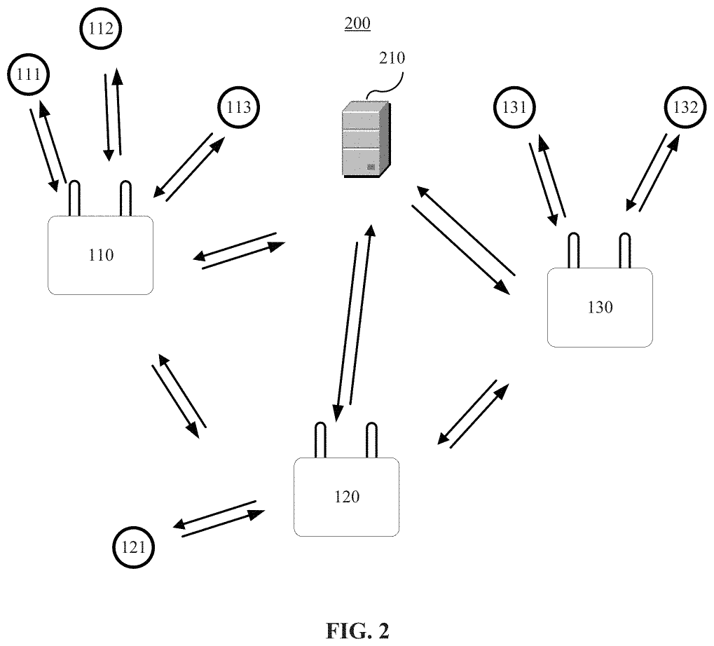

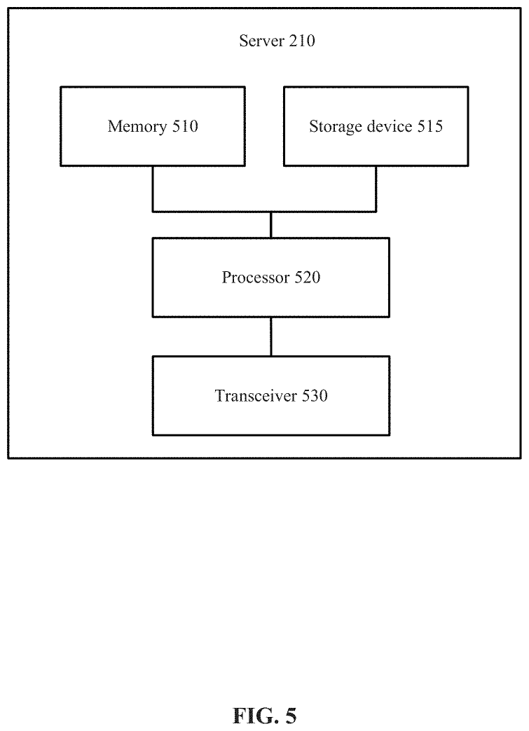

FIG. 2 is a schematic diagram of a system 200 including a plurality of movable devices. The system 200 is similar to the system 100, except for the addition of a server 210. The server 210 may include any computing devices, such as a personal computer, a workstation, a tablet, a smart phone. FIG. 5 is a schematic diagram of the server 210. The server 210 may include a memory 510 configured to store computer-executable instructions or codes that implement the disclosed methods. The memory 510 may include any suitable memories, such as a flash memory, a random access memory (“RAM”), a read-only memory (“ROM”), a programmable read-only memory (“PROM”), a field programmable read-only memory (“FPROM”), etc.

In some embodiments, the server 210 may also include a storage device 515. The storage device 515 may be configured to store data, including information received from one or more UAVs and/or one or more remote control devices. The storage device 515 may include any suitable devices, such as a hard disk, an optical disc, a magnetic disk, a solid state drive, a tape, a portable disk, a network drive, etc.

The server 210 may include a processor 520 (or microprocessor 520) configured to access the memory 510 and/or the storage device 515. In some embodiments, the processor 520 may be configured to execute the instructions stored in the memory 510 to perform various methods disclosed herein. The processor 520 may include any suitable processor, such as a central processing unit (“CPU”), a microprocessor, an application-specific instruction set processor (“ASIP”), a graphics processing unit (“GPU”), a physics processing unit (“PPU”), a digital signal processor (“DSP”), a network processor, etc. The processor 520 may be a single-core processor or a multi-core processor.

The server 210 may include a transceiver 530 configured to communicate with other components included in the system 200, such as the remote control devices. The transceiver 530 may include any suitable communication circuits, devices, interfaces, ports, antennas, etc. The transceiver 530 may be configured to transmit data to and receive data from other components included in the system 200. For example, the transceiver 530 may be communicatively coupled with the remote control devices 110, 120, and 130 through suitable wireless communication channels or links, such as Wi-Fi or cellular communication channels. The transceiver 530 may be configured to receive information relating to the UAVs from the remote control devices 110, 120, and 130.

In some embodiments, the processor 520 may process the information relating to the UAVs received by the transceiver 530. The processor 520 may instruct the transceiver 530 to transmit processed data back to the remote control devices 110, 120, and 130. For example, the processor 520 may determine (e.g., calculate) the priority levels and/or the safety zones of the UAVs based on the information relating to the UAVs received from the remote control devices 110, 120, and 130. The transceiver 530 may transmit data of the calculated priority levels and/or the safety zones to the remote control devices 110, 120, and 130, which may further transmit data of the priority levels and/or the safety zones to corresponding UAVs. In some embodiments, the server 210 may receive information relating to all of the UAVs included in the system 200, including, e.g., at least one of a location, a flight speed, a flight height, a flight direction, an attitude, a task, a quality of signal, an identification, a type of UAV, or a time when a connection is first established with a remote control device.

The processor 520 may process the information relating to all of the UAVs. For example, the processor 520 may calculate, for any UAV (e.g., UAV 111), a priority level and/or a safety zone for the UAV. The processor 520 may also calculate, for the UAV, priority levels and/or safety zones of other UAVs based on information relating to the other UAVs. In some embodiments, the processor 520 may calculate the priority levels and/or safety zones of all of the other UAVs included in the system 200, or only the other UAVs (e.g., UAVs 112 and 113) that are located within a predetermined distance from the UAV (e.g., UAV 111). The transceiver 530 may transmit the data relating to the priority levels and/or the safety zones of the UAV (e.g., UAV 111) and the other UAVs (e.g., all of the other UAVs or only UAVs 112 and 113) to the pertinent remote control device (e.g., the first remote control device 110), which may further transmit the data to the particular UAV (e.g., UAV 111) and/or other related UAVs. In this manner, each UAV in the system 200 may receive data of the priority levels and/or safety zones relating to itself and the other UAVs included in the system 200 (e.g., all of the other UAVs or only the other UAVs located within a predetermined distance from the UAV).

Referring back to FIG. 2, in some embodiments, the server 210 may function as a central processing hub configured to collect information relating to the UAVs in real time, process the information in real time, and sharing the processed information to the UAVs included in the system 200 in real time. In some embodiments, the server 210 may develop a collision avoidance measure for each of the UAV with respect to neighboring UAVs that are located within a predetermined distance from the UAV. The server 210 may transmit control signals to each of the UAV to instruct the UAV to carry out the collision avoidance measure, including, for example, reducing the speed of the UAV to avoid collision. The use of the server 210 may be desirable when there is a large amount of information to be processed, which may cause significant delay when the information is processed by the UAVs and/or the remote control devices.

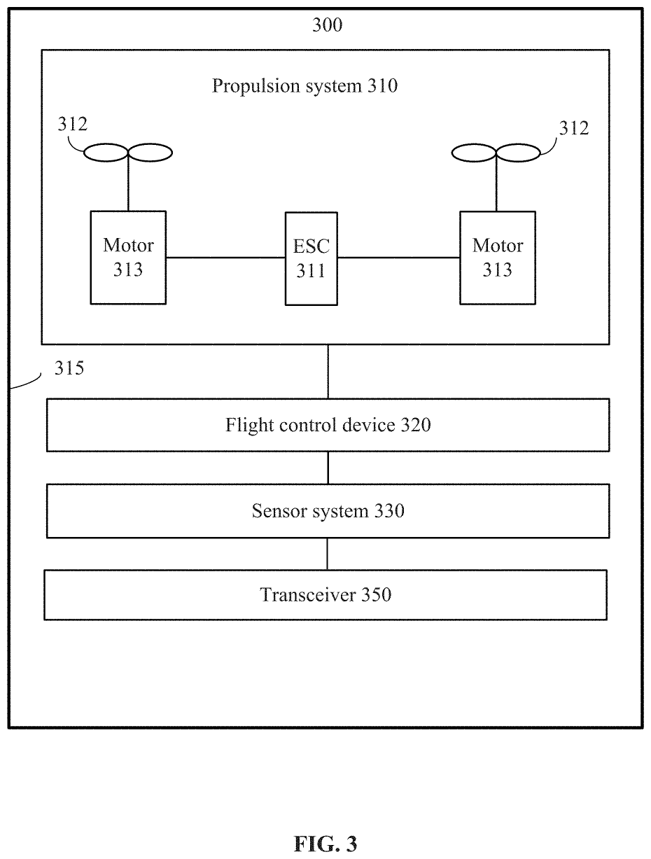

FIG. 3 is a schematic diagram of a movable device 300. Movable device 300 may be a UAV, an unmanned ground vehicle, a water surface vehicle, an underwater vehicle, a satellite, a flying object, etc. For discussion purposes, a UAV is shown in FIG. 3 as an example of the movable device 300 (hence movable device 300 may also be referred to as UAV 300). The UAV 300 may be an embodiment of any movable device or any UAV disclosed herein.

The UAV 300 may include a body 315. The body 315 may include a plurality of frames for mounting other members of the UAV 300. For example, the propulsion system 310 may be mounted to the body 315. In some embodiments, the body 315 may include a plurality of arms radially extending from a central frame of the body 315. Each propulsion assembly may be mounted to an arm. For example, in some embodiments, the motor 313 and the propeller 312 may be mounted to an end portion of an arm distant from the central portion of the body 315.

The UAV 300 may include a propulsion system 310 configured to provide a propulsion force for the flight of the UAV 300. The propulsion system 310 may include one or more propulsion assemblies. Each propulsion assembly may include at least one of a propeller 312 or a motor 313. Two propulsion assemblies are shown in FIG. 3 for illustration purposes only. The

UAV 300 may include any suitable number of propulsion assemblies, such as one, three, four, five, six, seven, eight, etc.

The propulsion system 310 may include one or more electric speed control (“ESC”) 311. The motor 313 may be electrically coupled between the ESC 311 and the propeller 312. The ESC 311 may be configured or programmed to receive a driving signal from a flight control device 320. The ESC 311 may be configured to provide a driving current to the motor 313 based on the driving signal received from the flight control device 320, thereby controlling a rotating speed and/or a rotating direction of the motor 313. Each motor 313 may drive the propellers 312 to rotate, thereby providing a propulsion force for the flight of the UAV 300.

The UAV 300 may include a flight control device 320. The flight control device 320 may be operably coupled with various components or devices included in the UAV 300. The flight control device 320 may function as a central controller for controlling the flight and/or the operations of various components or devices included in the UAV 300. For example, the flight control device 320 may be configured to generate a driving signal for the ESC 111 to control the rotating speed and/or the rotating direction of the motor 313. The flight control device 320 may also control the pitch angle, the yaw angle, and the roll angle of the UAV 300 during flight.

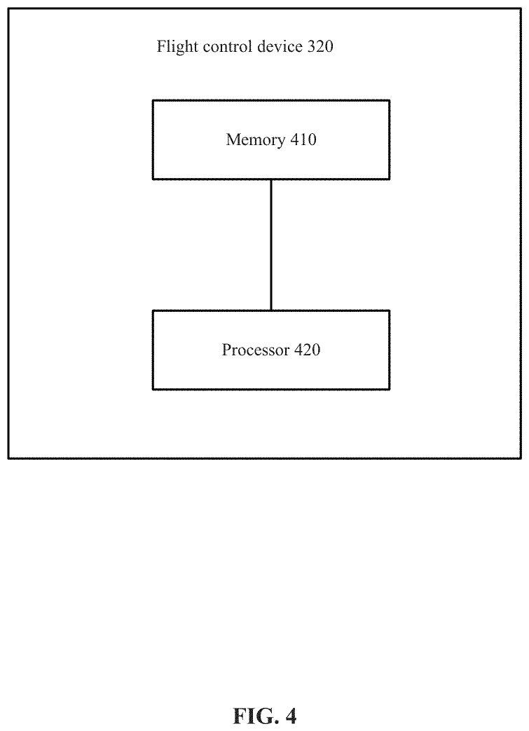

FIG. 4 is a schematic diagram of an example of the flight control device 320. The flight control device 320 may include a memory 410. The memory 410 may be configured to store computer-executable instructions or codes. The memory 410 may include any suitable memory discussed above (e.g., similar to memory 510). The flight control device 320 may include a processor 420 (or microprocessor 420). The processor 420 may include any suitable processors discussed above (e.g., similar to processor 520). The processor 420 may include various hardware components, such as circuits, gates, logic elements, etc. The processor 420 may be configured to access the memory 410 and execute the instructions stored therein to perform various methods disclosed herein, including the methods for controlling the movement (e.g., flight) of the UAV 300. In some embodiments, the flight control device 320 may include a hardware chip. The hardware chip may an application-specific integrated circuit (“ASIC”), a programmable logic device (“PLD”), or a combination thereof. The PLD may be a complex programmable logic device (“CPLD”), a field-programmable gate array (“FPGA”), a generic array logic (“GAL”), or any combination thereof.

The UAV 300 may include a sensor system 330 that may include any suitable sensors, such as a global positioning system (“GPS”) sensor, a real-time kinematic sensor, a visual-inertial odometry sensor, an inertial measurement unit, a microphone, an accelerometer, an imaging sensor (e.g., included in an imaging device carried by the UAV 300), an infrared sensor, a digital compass, a radar, a laser sensor, a thermal sensor, a night vision sensor, etc. The sensor system 330 may acquire, collect, detect, or measure information relating to the UAV 300 and the environment in which the UAV 300 is operated. For example, the GPS sensor may provide location information of the UAV 300. The radar and/or laser sensor may provide a measurement of a distance between the UAV 300 and another neighboring UAV or obstacle. Based on the measurement of the distance, the UAV 300 may have information about which UAVs are located within a predetermined distance from UAV 300, and which UAVs may pose a collision risk to the flight of the UAV 300.

In some embodiments, the UAV 300 may include a transceiver 350 configured to communicate with a remote control device, a communication base station (such as a cellular telecommunication network), or a satellite. For example, the transceiver 350 may include at least one of a 3G, 4G, or 4G Long Term Evolution (“LTE”) communication chip, a 5G or 5G New Radio (“NR”) communication chip, a Bluetooth communication device, a Wi-Fi communication device, or any other communication devices that may provide a suitable range of communication.

Although not shown in FIG. 3, the UAV 300 may include a power source that may include a battery. The battery may be any suitable battery, such as a rechargeable battery, a non-rechargeable battery, an alkaline battery, a Lithium Ion battery, a Nickel-Metal Hydride battery, a Nickel Cadmium battery, a lead acid battery, a Lithium Ion Polymer battery, etc. In some embodiments, the power source may include a solar panel and a battery. The solar panel may be configured to convert solar energy into electricity, which may be stored in the battery. The power source may include any other suitable devices for providing the power to drive the propulsion assemblies included in the UAV 300.

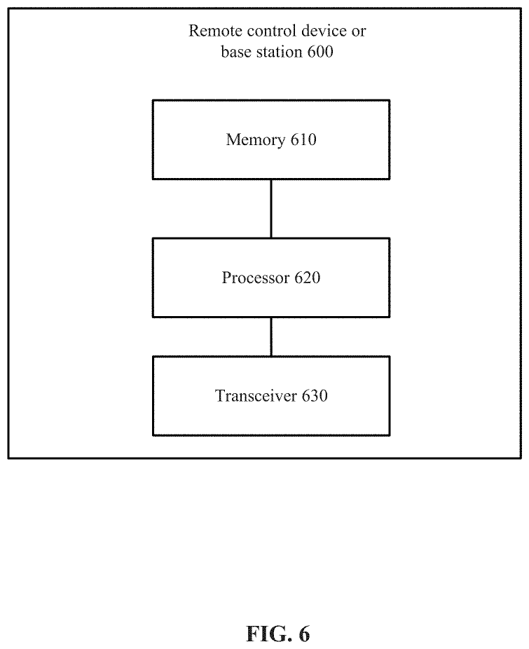

FIG. 6 is a schematic diagram of a remote control device or a base station 600 (hereinafter referred to as “remote control device 600” for simplicity). The remote control device 600 may be an embodiment of or a part of the remote control devices 110, 120, and 130. The remote control device 600 may include a memory 610, a processor 620 (or microprocessor 620), and a transceiver 630. The memory 610 may include any suitable memory discussed above in connection with memory 510. The processor 620 may include any suitable processor discussed above in connection with processor 520. The transceiver 630 may include any suitable transceiver discussed above in connection with transceiver 530.

The memory 610 may be configured to store computer-executable instructions or codes. The processor 620 may be configured to access the memory 610 and execute the instructions to perform various methods disclosed herein. The transceiver 630 may be configured to communicate with the UAVs, the other remote control devices included in the system 100 or 200, and/or the server 210. For example, the transceiver 630 may be configured to exchange data with the transceiver 350 included in the UAV 300. In some embodiments, the transceiver 630 may transmit control signals to the transceiver 350 of the UAV 300 to control the flight and other operations of the UAV 300. In some embodiments, the transceiver 630 may receive information relating to the UAV 300 from the transceiver 350. The information received may include various information relating to the UAV 300, including various data measured or acquired by the sensor system 330. Although not shown, the remote device may also include a data storage device, which may be similar to storage device 515 shown in FIG. 5.

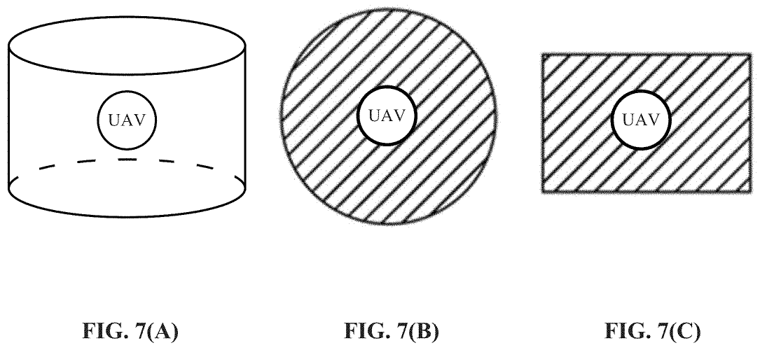

FIG. 7(A), FIG. 7(B), and FIG. 7(C) are schematic illustrations of safety zones for a UAV. FIG. 7(A) is a schematic illustration of a perspective view of a safety zone of a UAV. The safety zone may take any suitable shape, such as a spherical shape, a cylinder shape, a cubic shape, a rectangular prism shape, etc. For illustration and discussion purposes, the cylindrical shape is used as an example of the shape of the safety zone. As shown in FIG. 7(A), the UAV may be located in a center portion of the safety zone. A size of the safety zone may be represented by a dimension in a horizontal plane projection, and a dimension in a vertical plane projection.

FIG. 7(B) is a schematic illustration of a horizontal plane projection of the safety zone shown in FIG. 7(A). The horizontal plane projection of the cylindrical safety zone is a circle. As shown in FIG. 7(B), the horizontal plane projection of the UAV is at the center of the circle. The size of the circle may be represented by a radius of the circle. The radius of the circle may be determined based on various information relating to the UAV. For example, the radius of the circle may be determined based on a priority level of the UAV.

FIG. 7(C) is a schematic illustration of a vertical plane projection of the safety zone shown in FIG. 7(A). The vertical plane projection of the cylindrical safety zone is a rectangle. As shown in FIG. 7(C), the vertical plane projection of the UAV is at the center of the rectangle. The width of the rectangle equals to the diameter of the circle shown in FIG. 7(B), and the height of the rectangle equals to the height of the cylinder shown in FIG. 7(A). In some embodiments, the height of the cylinder may be determined based on a precision of a positioning system that provides location information of the UAV.

The safety zone of a UAV is a virtual, digital zone, rather than a physical zone. The function of the safety zone is to notify other UAVs a space that the UAV needs to occupy for safe flight, such that other UAVs do not enter into the safety zone of the UAV, thereby accomplishing collision avoidance. The size of the safety zone may be dependent on various factors. For example, the size of the safety zone may be dependent on the task performed by the UAV. If the task performed by the UAV has a higher importance level, the safety zone of the UAV may be larger (e.g., the radius of the circle shown in FIG. 7(B) may be larger). In some embodiments, the height of the safety zone may be determined based on a precision of a positioning system that provides location information of the UAV. For example, if a first positioning system has a precision of 10 meters, the safety zone of the UAV may have a height of about 15-20 meters. If a second positioning system has a precision of 5 meters, the safety zone of the UAV may have a height of about 10-15 meters. In some embodiments, if the UAV has a higher priority level, the radius of the safety zone may be larger.

In some embodiments, when every UAV possesses information about the safety zones of the other UAVs included in the system 100 or 200, an effective collision avoidance measure may be automatically or autonomously taken by every UAV to avoid collision with one another. Thus, autonomous collision avoidance may be carried out by the UAVs in the system 100 or 200. In some embodiments, a UAV may not need to possess information about the safety zone of every other UAV included in the system 100 or 200. Rather, the UAV may only need to possess information about the safety zone of certain UAVs that are located within a predetermined distance from the UAV. Such UAVs may be close to the UAV and may pose a collision risk to the UAV.

In some embodiments, the collision avoidance measure may be determined based on both the priority levels and the safety zones of the UAVs. In some embodiments, the collision avoidance measure may be determined based on the priority levels of the UAVs. In some embodiments, the collision avoidance measure may be determined based on the safety zones of the UAVs. In some embodiments, when velocities of two or more UAVs have both the vertical velocity components and the horizontal velocity components, the collision avoidance measure may include horizontal collision avoidance and vertical collision avoidance. In some embodiments, when the velocities of two or more UAVs have only the vertical velocity components, the collision avoidance measure may be carried out only in the vertical direction or vertical plane (e.g., vertical collision avoidance). When the velocities of two or more UAVs have only the horizontal velocity components, the collision avoidance measure may be carried out only in the horizontal direction or horizontal plane (e.g., horizontal collision avoidance).

In some embodiments, the collision avoidance measure may be performed in the three-dimensional space without separating the horizontal collision avoidance and vertical collision avoidance. In such embodiments, the collision avoidance measure may be determined based on the three-dimensional velocities of the two or more UAVs. For example, the safety zones of the UAVs may not need to be projected onto the horizontal plane and the vertical plane. Rather, the three-dimensional size data, three-dimensional velocity data, and three-dimensional location data of the safety zones and the UAVs may be shared with each other. For example, UAV 111 may receive information relating to the three-dimensional velocity, size, and location of UAV 112. UAV 111 may receive or determine a safety zone for UAV 112. UAV 111 may determine, based on its velocity and the velocity of UAV 112, whether there is a crossing point in their projected travel paths. If there is a crossing point, UAV 111 may compare the priority level of itself and the priority level of UAV 112. In some embodiments, UAV 111 may determine the priority level of UAV 112 prior to the comparison. If the priority level of UAV 111 is smaller than the priority level of UAV 112, UAV 111 may carry out a three-dimensional collision avoidance measure, e.g., by reducing its speed until it hovers (e.g., speed is zero) at an outer vertical edge of the safety zone of UAV 112. After UAV 112 safely passes the crossing point, UAV 111 may proceed along its travel path. In some embodiments, UAV 111 may directly compare the safety zone of itself and the safety zone of UAV 112. If the safety zone of UAV 111 is smaller than the safety zone of UAV 112, UAV 111 may carry out a collision avoidance measure to avoid collision with UAV 112, e.g., by reducing its speed until it hovers at an outer vertical edge of the safety zone of UAV 112. In some embodiments, UAV 111 may reduce its speed until an outer vertical edge of the safety zone of UAV 111 reaches an outer vertical edge of the safety zone of UAV 112. In some embodiments, if the priority level of UAV 111 is greater than the priority level of UAV 112, UAV 111 may continue to move along its travel path without reducing its speed, and UAV 112 may carry out a collision avoidance measure. In some embodiments, if the safety zone of UAV 111 is greater than the safety zone of UAV 112, UAV 111 may continue to move along its travel path without reducing its speed, and UAV 112 may carry out a collision avoidance measure.

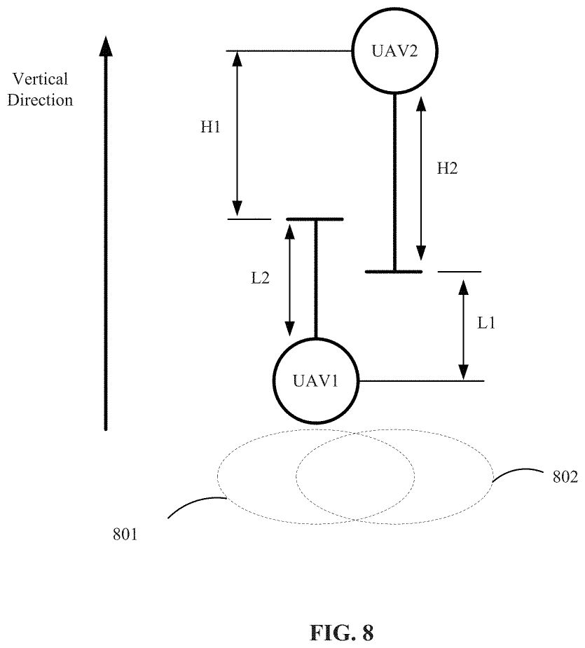

FIG. 8 is a schematic illustration of a vertical collision avoidance measure. As shown in FIG. 8, safety zones of UAV1 and UAV2 may have horizontal plane projections 801 and 802 that overlap each other. When UAV1 and UAV2 move toward each other vertically, each of the UAV1 and UAV2 may autonomously take a vertical collision avoidance measure to avoid collision with each other. In FIG. 8, H1 represents a distance between UAV2 and an upper vertical edge of a vertical plane projection of the safety zone of UAV1, and L 1 represents a distance between UAV1 and a lower vertical edge of a vertical plane projection of the safety zone of UAV2. H2 represent half of the height of the vertical plane projection of the safety zone of UAV2. L2 represents half of the height of the vertical plane projection of the safety zone of UAV1. Each of the UAV1 and UAV2 may compare L1 with H1 and take a lower one of L1 and H1 as an initial distance. For example, if L1 is smaller than H1, L1 may be taken as the initial distance. Both UAV1 and UAV2 may reduce their respective speed (velocity in the vertical direction) based on L1. The speed reduction scheme may include: reducing the upward moving speed of UAV1 until about zero and reducing the downward moving speed of UAV2 until about zero, when the initial distance is reduced to about zero. That is, when the initial distance L1 is reduced to about zero, UAV1 and UAV2 each may reach a zero speed in the vertical direction. In other words, UAV1 and UAV2 may hover in the air when the initial distance L1 is reduced to about zero. When L1 is reduced to about zero, the vertical velocity of UAV1 or UAV2 becomes about zero.

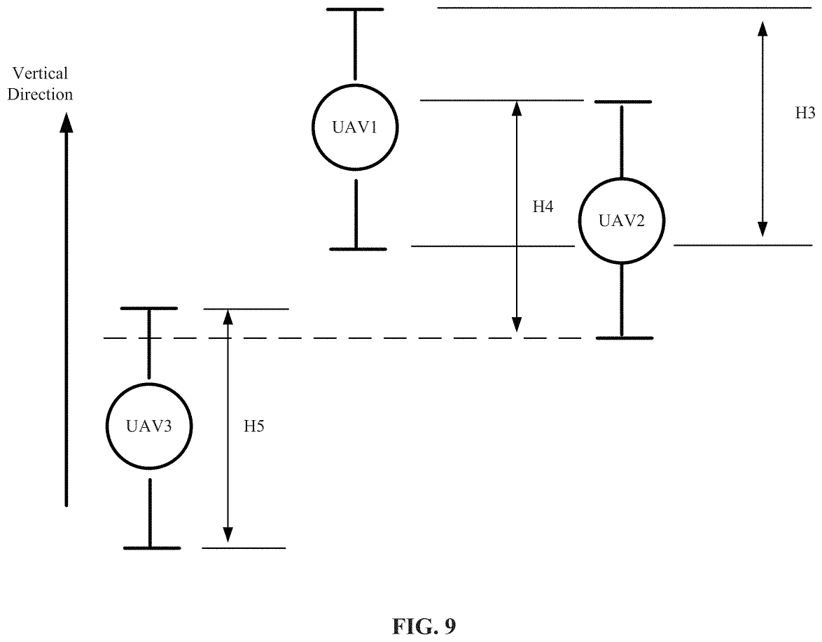

FIG. 9 is a schematic illustration of a vertical layer separation scheme. The vertical layer separation scheme may be carried out by at least one of a UAV, a remote control device, a base station, or a server. As shown in FIG. 9, UAV1, UAV2, and UAV3 are located at different heights. For collision avoidance purposes, because there may be errors in the measurement of the flight heights of the UAVs, UAVs located in a predetermined vertical height range may be treated as being located in a same vertical region. UAVs located in the same vertical region may take a horizontal collision avoidance measure to avoid collision with one another when moving horizontally. In some embodiments, a first UAV may determine whether a first movement height of the first UAV and a second movement height of a second UAV in the vertical direction are within a predetermined height range. For example, UAV1 may have a safety zone having a height H3. UAV2 is located within a vertical region defined by the height H3 of the safety zone of UAV1. In other words, the first movement height of UAV1 (e.g., the height of flight of UAV1) and the second movement height of UAV 2 (e.g., the height of flight of UAV2) are located in a predetermined vertical height range (e.g., H3). Therefore, from the perspective of UAV1, UAV2 is treated as being located in the same vertical region as UAV1, and hence UAV2 may pose a collision risk. Accordingly, when the priority level of UAV1 is smaller than the priority level of UAV2, UAV1 may autonomously carry out a horizontal collision avoidance measure to avoid collision with UAV2. UAV3 is located outside of the vertical region defined by the height H3 of the safety zone of UAV1. Thus, UAV3 is not located within the predetermined vertical height range (e.g., H3). Therefore, from the perspective of UAV1, UAV3 does not pose a collision risk. Accordingly, even if the priority level of UAV1 is smaller than the priority level of UAV3, UAV1 may not take a horizontal collision avoidance measure with respect to UAV3.

As shown in FIG. 9, UAV1 is located within a vertical region defined by a height H4 of the safety zone of UAV2. Accordingly, from the perspective of UAV2, UAV1 is treated as being located within the same vertical region as UAV2, and may pose a collision risk in horizontal movement. Therefore, UAV2 may autonomously carry out a horizontal collision avoidance measure to avoid collision with UAV1. UAV3 is located outside of the vertical region defined by the height H4 of the safety zone of UAV2. Therefore, from the perspective of UAV2, UAV3 is not treated as being located in the same vertical region as UAV2, and hence does not pose a collision risk. Accordingly, UAV2 may not take a horizontal collision avoidance measure with respect to UAV3. For UAV3, a vertical region is defined by a height H5 of the safety zone of UAV3. Both UAV1 and UAV2 are located outside of the vertical region associated with UAV3. Therefore, from the perspective of UAV3, UAV1 and UAV2 do not pose a collision risk in horizontal movement. Accordingly, UAV3 may not take a horizontal collision avoidance measure with respect to UAV1 and UAV2.

The disclosed vertical layer separation scheme divides UAVs into different heights, with some UAVs located within a predetermined vertical height range being treated as located at a same height, thereby invoking collision avoidance measures. This can avoid horizontal collision that would otherwise be caused due to errors in the measurement of the flight heights of the UAVs. It is noted that the concept of vertical region is different from the concept of safety zone. The vertical region is only used to determine whether a UAV is located in the same vertical region as another UAV. The vertical region may be significantly larger than the safety zone in the horizontal direction as it may extend horizontally with an arbitrary limit. The vertical region is not used to determine whether a UAV is located within a safety zone of another UAV.

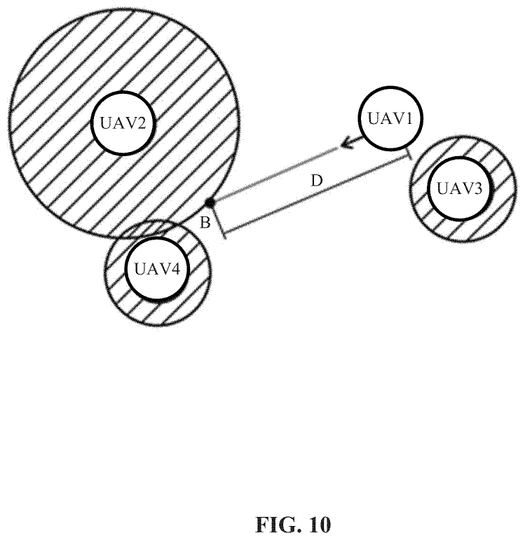

FIG. 10 is a schematic illustration of an example of a horizontal collision avoidance measure. The disclosed collision avoidance measure may be autonomously taken by a UAV (e.g., UAV1) based on a priority level and/or a safety zone determined by the UAV for other UAVs. Assuming UAV1 is the UAV that takes the horizontal collision avoidance measure to avoid collision with other UAVs, UAV1 may determine the priority levels and/or safety zones of other neighboring UAVs. In some embodiments, a remote control device and/or server 210 may determine priority levels and/or safety zones for the other neighboring UAVs, as well as the priority level and/or the safety zone of UAV1. The remote control device and/or server 210 may provide the priority levels and/or safety zones to UAV1. Although UAV1 is used as an example entity that carries out the horizontal collision avoidance measure, a person having ordinary skill in the art can appreciate that similar horizontal collision avoidance measure may be carried out by other UAVs individually.

In some embodiments, UAV2, UAV3, UAV4 may share their respective information with UAV1. The information shared by the UAVs has been discussed above. The information shared by the UAVs may include at least one of the following information relating to a UAV: a location, a flight height, a flight speed, a flight direction, attitude, a task, a quality of signal, an identification, a type of the UAV, or a time when a connection is established with a remote control device. Based on the information shared by the UAV2, UAV3, and UAV4, in some embodiments, UAV1 may determine priority levels and/or safety zones for UAV2, UAV3, and UAV4. In some embodiments, the height of the safety zone of UAV2, UAV3, or UAV4 may be determined by UAV1 based on a precision of the positioning system (e.g., the GPS system) that provides location information of UAV2, UAV3, or UAV4. A horizontal dimension, e.g., a radius of the circle in the horizontal plane, which is the horizontal plane projection of the safety zone of UAV2, UAV3, or UAV4, may be determined by UAV1 based on the respective priority level of UAV2, UAV3, or UAV4 that is determined by. In some embodiments, the higher the priority level, the larger the radius of the circle (i.e., the larger the horizontal dimension in the horizontal plane projection of the safety zone). Example horizontal plane projections of the safety zones of UAV2, UAV3, and UAV4, as calculated by UAV1, are shown in FIG. 10. FIG. 10 shows that the safety zone of UAV2 may have a largest size in the horizontal plane projection, and the safety zones of UAV3 and UAV4 may have a similar size in the horizontal plane projections. The safety zone of UAV1 is not shown in FIG. 10.

In some embodiments, UAV1 may also determine a priority level and a safety zone for itself. The priority level of UAV1 may be determined based on at least one of the following information relating to UAV1: a location, a flight height, a flight speed, a flight direction, attitude, a task, a quality of signal, an identification, a type of the UAV1, or a time when a connection is established with a remote control device. The safety zone may be determined in a manner similar to the method discussed above in connection with UAV2, UAV3, and UAV4.

Still in FIG. 10, when UAV1 moves in a direction as indicated by the arrow, an extension of the moving direction of UAV1, e.g., the projected travel path of UAV1, may have a crossing point B on the circle, e.g., the horizontal plane projection of the safety zone of UAV2. A distance D may be determined between UAV1 and the crossing point B. Based on a determination that the priority level of UAV1 is smaller than the priority level of UAV2, UAV1 may carry out a horizontal collision avoidance measure by reducing the speed of UAV1 based on the distance D, such that when UAV1 reaches the crossing point B (or a location corresponding to crossing point B), the horizontal speed of UAV1 becomes zero. In other words, at point B, UAV1 may hover in the air. UAV1 may not move forward at crossing point B until UAV2 has passed by UAV1 such that UAV1 does not pose a collision risk to UAV2. In some embodiments, UAV1 may not start reducing its speed until distance D is smaller than a predetermined distance DO.

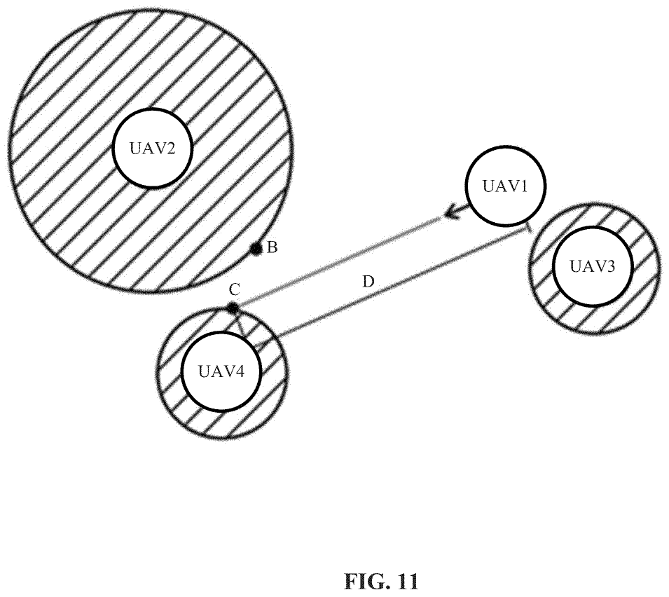

FIG. 11 is a schematic illustration of another example of a horizontal collision avoidance measure. As shown in FIG. 11, the direction of movement of UAV1 is indicated by the arrow. An extension of the direction of velocity of UAV1, i.e., the projected travel path of UAV1, may have a crossing point C with a horizontal plane projection of a safety zone of UAV4. The distance between UAV1 and the crossing point C is represented by distance D. Based on a determination that the priority level of UAV1 is smaller than the priority level of UAV4, UAV1 may carry out a horizontal collision avoidance measure by reducing its speed based on the distance D. The reduction in speed for UAV1 may be similar to that discussed above in connection with FIG. 10. At crossing point C, the speed of UAV1 may become zero. In other words, at point C, UAV1 may hover in the air. UAV1 may not move forward at crossing point C until UAV4 has passed by UAV1 such that UAV1 does not pose a collision risk to UAV4. In some embodiments, UAV1 may not start reducing its speed until distance D is smaller than a predetermined distance D0.

As shown in FIG. 11, the extension of the direction of velocity of UAV1 does not have a crossing point with UAV3. UAV1 may not take a horizontal collision avoidance measure with respect to UAV3.

UAV1 may determine the priority levels of all of the other UAVs included in the system 100 or 200. In some embodiments, UAV1 may determine the priority levels for only those neighboring UAVs that are located within a predetermined distance from UAV1. The priority levels may be determined based on the information shared by the other UAVs. Such information may include at least one of a location, a flight speed, a flight height, a flight direction, an attitude, a task, a quality of signal, an identification, a type of UAV, or a time when a connection is first established with a remote control device. In some embodiments, UAV1 may compare the priority levels with the priority level of UAV1. Based on a result of the comparison, UAV1 may determine the safety zones for the other UAVs. For example, the size of the safety zone of UAV2 may be determined based a difference between the priority level of UAV2 and the priority level of UAV1. In some embodiments, a greater difference in the priority level (assuming priority level of UAV2 is greater than priority level of UAV1) may result in a larger safety zone in UAV2. In some embodiments, UAV1 may calculate a safety zone for itself, and the sizes of the other UAVs may be determined relative to the size of the safety zone of UAV1.

Among the other UAVs, the priority levels may all be different, such that the sizes of the safety zones of the other UAVs may be different. In some embodiments, some of the other UAVs may have the same priority level and the sizes of the safety zones may be the same. In some embodiments, none of the priority levels of the other UAVs, as calculated by UAV1, is the same as the priority level of UAV1. The priority levels of the other UAVs are either greater than or smaller than the priority level of UAV1. Thus, in some embodiments, each UAV may have a unique priority level.

For the other UAVs, UAVs having priority levels greater than the priority level of UAV1 may have safety zones that are larger than safety zones of UAVs having priority levels smaller than the priority level of UAV1. In some embodiments, safety zones of UAVs having priority levels greater than the priority level of UAV1 may have the same size (e.g., a same large size), and safety zones of UAVs having priority levels smaller than the priority level of UAV1 may have the same size (e.g., a same small size). In some embodiments, the safety zones of UAVs having priority levels greater than the priority level of UAV1 may have different sizes (e.g., different large sizes), and safety zones of UAVs having priority levels smaller than the priority level of UAV1 may have different sizes (e.g., different small sizes).

In some embodiments, UAV1 may calculate priority levels for all of the other UAVs included in the system 100 (or 200) or only for the neighboring UAVs that are located within a predetermined distance from UAV1 based on locations of the UAVs. For example, UAVs that are located farther away from UAV1 may have lower priority levels, and UAVs that are located closer to UAV1 may have higher priority levels.

UAV1 may calculate priority levels for all of the other UAVs included in the system 100 (or 200) or only for the neighboring UAVs that are located within a predetermined distance from UAV1 based on the flight speeds of the UAVs. For example, UAVs traveling at higher speeds (e.g., higher than may have higher priority levels, and UAVs traveling at lower speeds may have lower priority levels.

In some embodiments, UAV1 may calculate priority levels for all of the other UAVs included in the system 100 or only for the neighboring UAVs that are located within a predetermined distance from UAV1 based on the flight heights of the UAVs. For example, UAVs flying at a greater height (relative to UAV1) may have higher priority levels, and UAVs flying at a lower height (relative to UAV1) may have lower priority levels.

In some embodiments, UAV1 may calculate priority levels for all of the other UAVs included in the system 100 (or 200) or only for the neighboring UAVs that are located within a predetermined distance from UAV1 based on the flight directions of the UAVs. For example, UAVs flying at directions opposite to the direction of movement of UAV1 may be associated with lower priority levels, and UAVs flying at directions toward the direction of movement of UAV1 may be associated with higher priority levels.

In some embodiments, UAV1 may calculate priority levels for all of the other UAVs included in the system 100 (or 200) or only for the neighboring UAVs that are located within a predetermined distance from UAV1 based on the attitude of the UAVs. For example, the attitude of a UAV may include a pitch angle, a yaw angle, and a roll angle. UAVs having pitch angles pointing away from the projected travel path of UAV1 may be associated with lower priority levels, and UAVs having pitch angles pointing toward the projected travel path of UAV1 may be associated with higher priority levels.

In some embodiments, UAV1 may calculate priority levels for all of the other UAVs included in the system 100 (or 200) or only for the neighboring UAVs that are located within a predetermined distance from UAV1 based on the tasks carried out by the UAVs. For example, UAV1 may calculate priority levels for another UAV based on an importance level of the task carried out by the other UAV. For example, when UAV2 is carrying out an important task, UAV1 may calculate a relatively greater priority level for UAV2, and may further calculate a relatively larger safety zone for UAV2 based on the calculated priority level for UAV2.

In some embodiments, UAV1 may calculate priority levels for all of the other UAVs included in the system 100 (or 200) or only for the neighboring UAVs that are located within a predetermined distance from UAV1 based on the quality of signals of the UAVs. The quality of signals may refer to the quality of signals communicated between the UAVs with a particular remote control device. For example, UAV1 may compare the quality of signals of another UAV with the quality of signals of UAV1, and may assign a priority level based on the difference in the quality of signals.

In some embodiments, UAV1 may calculate the priority levels for all of the other UAVs included in the system 100 (or 200) or only for the neighboring UAVs that are located within a predetermined distance from UAV1 based on identifications of the UAVs. Each UAV may have an identification, such as a serial number, which may be unique. UAV1 may compare the serial numbers of the other UAVs with the serial number of UAV1 to determine the priority levels for the other UAVs. For example, a UAV having a larger serial number may be assigned with a lower priority level, and a UAV having a smaller serial number may be assigned with a higher priority level.

In some embodiments, UAV1 may calculate the priority levels for all of the other UAVs included in the system 100 (or 200) or only for the neighboring UAVs that are located within a predetermined distance from UAV1 based on the type of the UAV. The priority levels for different types of UAVs may be different. For example, priority level may be 1.0 for an agriculture UAV, priority level may be 2.0 for an entertainment UAV, priority level may be 3.0 for a surveillance UAV, etc. Priority level may be 1.0 for a four-axis UAV, priority level may be 2.0 for a six-axis UAV, and priority level may be 3.0 for an eight-axis UAV, etc.

In some embodiments, UAV1 may calculate the priority levels for all of the other UAVs included in the system 100 (or 200) or only for the neighboring UAVs that are located within a predetermined distance from UAV1 based on a time when a connection is first established with a remote control device. For example, the remote control device 110 may control a plurality of UAVs. Each UAV may join the group or network of UAVs controlled by the remote control device 110 by establishing a communication with the remote control device 110 using a specified communication protocol. Each UAV may join the network controlled by the remote control device 110 at different times (e.g., different dates and/or different hours, minutes, seconds, etc.). In some embodiments, the times may be unique. In some embodiments, an earlier time may be assigned with a higher priority level. For example, UAV1 may join the network at 08:00 a.m., UAV2 may join the network at 08:05 a.m., and UAV3 may join the network at 08:10 a.m. Each time may correspond to a priority level. In some embodiments, the earlier time may correspond to a higher priority level. For example, the priority level for UAV1 may be 5.0 for the joining time of 08:00 a.m., the priority level for UAV2 may be 4.0 for the joining time of 08:05 a.m., and the priority level for UAV3 may be 3.0 for the joining time of 08:10 a.m.

The priority levels of the UAVs may satisfy the following rules. First, the priority levels of the other UAVs are either greater than or smaller than the priority level of UAV1 itself. There is no priority level of the other UAVs that is the same as the priority level of UAV1. Thus, each of the other UAVs may have a different priority level compared to UAV1. Second, a relationship between a second priority level and a first priority level corresponds to a relationship between a third priority level determined by the second movable device for the second movable device and a fourth priority level determined by the second movable device for the first movable device. For example, when UAV1 determines a first priority level for itself, and a second priority level for UAV2, and when UAV2 determines a third priority level for itself and a fourth priority level for UAV1, the relationship between the second priority level and the first priority level, as determined by UAV1, corresponds to (e.g., is the same as) the relationship between the third priority level and the fourth priority level, as determined by UAV2. In some embodiments, when UAV1 calculates a priority level for UAV2 that is higher (or lower) than the priority level of UAV1 calculated by UAV1, UAV2 also calculates a priority level for UAV1 that is lower (or higher) than the priority level of UAV2 calculated by UAV2. Third, a lower priority level may correspond to or may indicate a smaller safety zone, and a higher priority level may correspond to or may indicate a larger safety zone. Thus, higher priority levels may indicate better collision protection for a UAV due to the safety zone of a larger size.

In some embodiments, UAV1 may determine a safety zone for another UAV based on the priority level calculated for the other UAV. For example, the safety zone for UAV2 may be proportional to the priority level of UAV2. In some embodiments, the higher the priority level, the larger the safety zone (e.g., the larger the radius of the circle in the horizontal plane projection of the safety zone). In some embodiments, UAV1 may directly calculate the safety zones for the other UAVs based on the information shared by the other UAVs, rather than calculating the safety zones based on the priority levels.

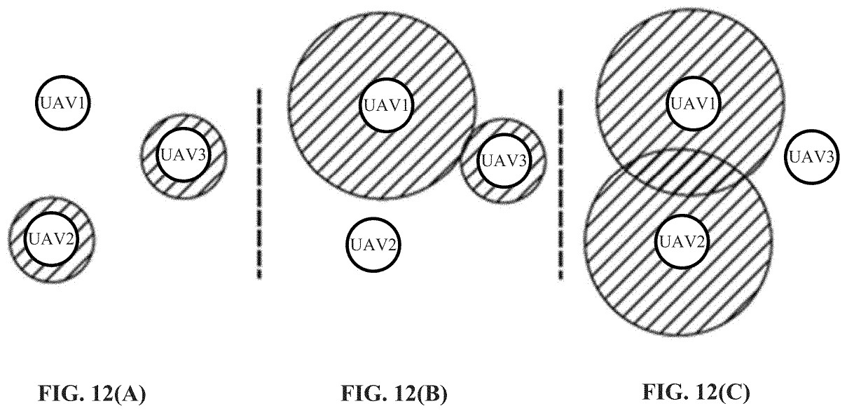

FIG. 12(A) is a schematic illustration of safety zones of other UAVs calculated by a first movable device, such as UAV1. Assuming that the priority level of UAV1 is greater than the priority level of UAV2, which is greater than the priority level of UAV3. When UAV1 calculates the safety zones for UAV2 and UAV3, the safety zones may have sizes as indicated in FIG. 12(A). Both safety zones of UAV2 and UAV3 may be small safety zones (from the perspective of UAV1) corresponding to low priority levels. In some embodiments, the safety zones of UAV2 and UAV3 may have horizontal plane projections of the same size. In some embodiments, the safety zones of UAV2 and UAV3 may have horizontal plane projections of different sizes. In some embodiments, the safety zones of UAV2 and UAV3 may be smaller than the safety zone of UAV1.

FIG. 12(B) is a schematic illustration of safety zones calculated by a second movable device, e.g., UAV2. When UAV2 calculates the safety zones for UAV1 and UAV3, because the priority level of UAV1 is greater than the priority level of UAV2, UAV2 may determine a large safety zone for UAV1. Because the priority level of UAV3 is smaller than the priority level of UAV2, UAV2 may determine a small safety zone for UAV3.

FIG. 12(C) is a schematic illustration of safety zones calculated by a third movable device, e.g., UAV3. Because the priority levels of UAV1 and UAV2 are both greater than the priority level of UAV3, UAV3 may determine large safety zones for both UAV1 and UAV2. In some embodiments, the safety zones of UAV1 and UAV2 may have horizontal plane projections of the same size. In some embodiments, the safety zones of UAV1 and UAV2 may have horizontal plane projections of different sizes. In some embodiments, the safety zones of UAV1 and UAV2 are larger than the safety zone of UAV3.

In some embodiments, other UAVs having higher priority levels (as compared to the priority level of a UAV that performs the calculation of the safety zones) may have safety zones of a same large size, and other UAVs having lower priority levels (as compared to the priority level of the UAV) may have safety zones of a same small size, as shown in FIG. 12(A) and FIG. 12(C). In other words, in some embodiments, there may be only two sizes for the safety zones, a predetermined large size and a predetermined small size, at least for the horizontal plane projections of the safety zones. In some embodiments, each different priority level may correspond to a different size for the safety zone. For example, when the priority level of UAV2 is greater than the priority level of UAV3, the safety zone of UAV2 calculated by UAV1 may have a larger size than the safety zone of UAV3 calculated by UAV1.

As shown in FIG. 12(A) and FIG. 12(C), with respect to UAV2, the safety zones calculated by UAV1 and UAV3 are different. From the perspective of UAV1, the safety zone of UAV2 is a small one (corresponding to lower priority level), whereas from the perspective of UAV3, the safety zone of UAV2 is a large one (corresponding to a higher priority level). Thus, in some embodiments, the size of the safety zone for a particular UAV depends on the comparison of the priority level of the UAV with the priority level of the UAV that performs the calculation. Thus, in some embodiments, for the system 100 or 200, every UAV has its own location and status, as well as its own unique priority level. In some embodiments, the size of the safety zone of every UAV depends on the relative relationship between the priority levels of the UAV and a UAV that performs the calculation of the safety zone (i.e., the UAV that takes the collision avoidance measure).

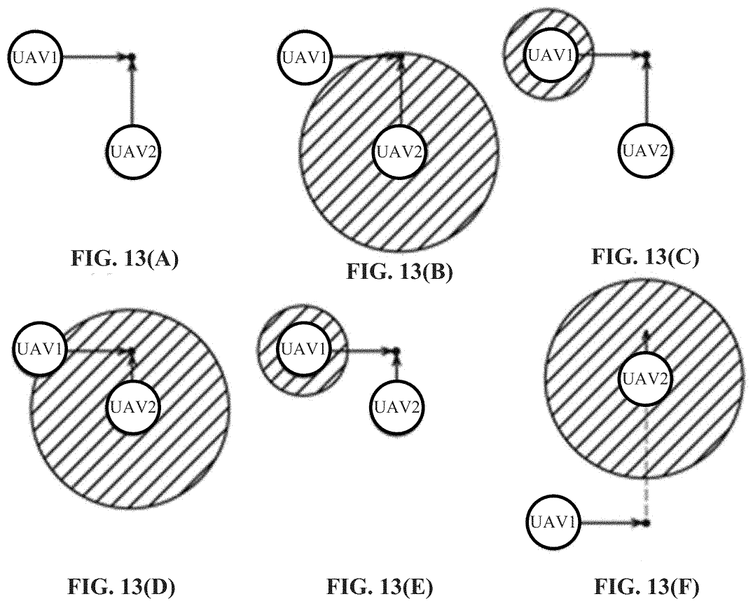

FIG. 13(A)-13(F) illustrates collision avoidance when the flight paths of different UAVs have a crossing point. FIG. 13(A) is a schematic illustration of a scenario in which projected flight paths of two UAVs have a crossing point. In FIG. 13(A), the projected flight paths of UAV1 and UAV2 have a crossing point. UAV1 and UAV2 may fly toward the crossing point at the same speed. If no collision avoidance measure is taken, UAV1 and UAV2 may collide at the crossing point. If the safety zones of UAV1 and UAV2 have the same size, when they approach the crossing point, the safety zones of the same size may prevent them from moving forward. UAV1 and UAV2 may get stuck at that point, and may not be able to successfully carry out the tasks they are assigned to.

FIG. 13(B) is a schematic illustration of a collision avoidance measure based on priority levels and/or safety zones. Assuming UAV2 has a higher priority level than UAV1, then from the perspective of UAV1, UAV2 has a larger safety zone (as compared to the safety zone of UAV1). When UAV1 approaches the safety zone of UAV2, UAV1 may take a collision avoidance measure, such as the horizontal collision avoidance measure discussed above in connection with FIG. 10 and FIG. 11. For example, UAV1 may reduce its speed and may hover at a point near the safety zone of UAV2, until UAV2 passes by safely. UAV1 may then move forward along its travel path.

FIG. 13(C) is a schematic illustration of a collision avoidance measure based on priority levels and/or safety zones. From the perspective of UAV2, UAV1 has a small safety zone. Thus, UAV2 may not reduce its speed, or may reduce its speed at a rate lower than a rate at which the speed of UAV1 is reduced.

FIG. 13(D) is a schematic illustration of a collision avoidance measure based on priority levels and/or safety zones. In this scenario, UAV2 has a higher priority level than UAV1, and thus has a large safety zone. UAV1 may take the collision avoidance measure by reducing its speed. UAV2 may or may not reduce its speed. UAV1 may stop at a location (e.g., hover at the location) when it reaches a crossing point with an outer edge of the safety zone (e.g., a horizontal plane projection of the safety zone) of UAV2, as discussed above in connection with FIG. 10. UAV1 may wait until UAV2 passes by safely. UAV1 may then move forward along its travel path.

FIG. 13(E) is a schematic illustration of a collision avoidance measure based on safety zones. Because the safety zone of UAV1, as calculated by UAV2, is a small one, UAV2 may not reduce its speed. In some embodiments, the UAV2 may passes the crossing point of the travel paths at full speed without reducing its speed.

FIG. 13(F) is a schematic illustration of movement of two UAVs after passing the crossing point. After UAV2 passes the crossing point of the travel paths, UAV1 may safely pass the crossing point and continue to travel along its travel path.

As shown in FIGS. 13(A)-13(F), the collision avoidance measure enables a UAV having a higher priority level to pass a crossing point of travel paths at its full speed without reducing its speed. A UAV having a lower priority level may reduce its speed or stop moving forward (e.g., may hover at a location) until the UAV having the higher priority level passes by. Although FIGS. 13(A)-13(F) show the travel paths cross each other perpendicularly, the collision avoidance measure may also be applicable to scenarios where the travel paths cross each other non-perpendicularly at any angle. Although FIGS. 13(A)-13(F) show only two UAVs having a crossing point in their travel paths, the disclosed collision avoidance measure may also be applicable to scenarios of more than two UAVs having a crossing point in their travel paths.

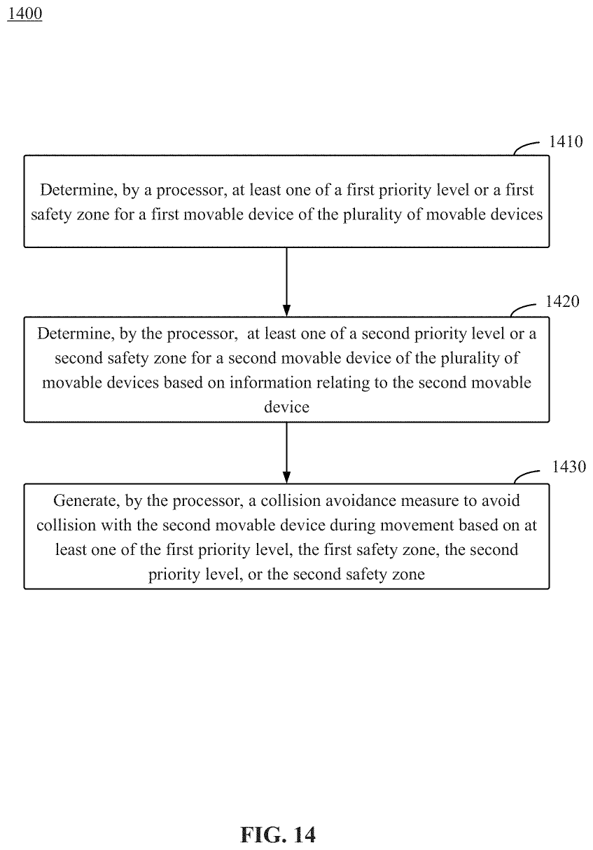

FIG. 14 is a flow chart illustrating a method 1400 for controlling movement of movable devices. Method 1400 may be performed by any individual UAV included in the system 100. For example, method 1400 may be performed by the flight control device 320 included in each UAV. Method 1400 may include determining, by a processor, at least one of a first priority level or a first safety zone for a first movable device of the plurality of movable devices (step 1410). For example, in the system 100 shown in FIG. 1, a processor of UAV 111 (an example of the first movable device) may determine a first priority level and a first safety zone for itself In some embodiments, UAV 111 may only determine one of the first priority level and the first safety zone, but not both. In some embodiments, UAV 111 may determine the first priority level and the first safety zone based on at least one of a location, a flight speed, a flight height, a flight direction, an attitude, a task, a quality of signal, an identification, a type of UAV, or a time when a connection is first established with a remote control device. In some embodiments, UAV 111 may determine its own priority level based on the information of itself, and may determine its safety zone based on the priority level. In some embodiments, UAV 111 may determine its safety zone directly based on the information of itself.

Method 1400 may also include determining, by the processor, at least one of a second priority level or a second safety zone for a second movable device of the plurality of movable devices based on information relating to the second movable device (step 1420). For example, other UAVs (e.g., UAV 112, UAV 113, UAV 121, UAV 131, UAV 132) may share their information with UAV 111, either through one or more remote control devices, or through a cellular telecommunication base station or network. UAV 111 may determine a second priority level and a second safety zone for any of the other UAVs (which may be an example of the second movable device) that shared information with UAV 111. In some embodiments, UAV 111 may determine a second priority level and a second safety zone for only those other UAVs that are located within a predetermined distance from UAV 111. This may reduce some computational cost. The information shared by any of the other UAVs may include at least one of a location, a flight speed, a flight height, a flight direction, an attitude, a task, a quality of signal, an identification, a type of UAV, or a time when a connection is first established with a remote control device. UAV 111 may determine the second priority level and the second safety zone for a second UAV (e.g., UAV 112) based on the information shared by UAV 112. In some embodiments, UAV 111 may determine the second priority level for UAV 112 first, and then determine the second safety zone based on the second priority level. In some embodiments, UAV 111 may directly determine the second safety zone without determining the second priority level first. In some embodiments, UAV 111 may compare the second priority level with the first priority level (i.e., the priority level of UAV 111) and determine the second safety zone based on the comparison of the priority levels (e.g., based on the difference between the first priority level and the second priority level). In some embodiments, UAV 111 may compare the second priority level with the first priority level (i.e., the priority level of UAV 111) and determine the second safety zone based on the difference between the first priority level and the second priority level, and the first safety zone.

Method 1400 may also include generating, by the processor, a collision avoidance measure to avoid collision with the second movable device during movement based on at least one of the first priority level, the first safety zone, the second priority level, or the second safety zone (step 1430). For example, UAV 111 may generate and carry out a collision avoidance measure to avoid collision with the second movable device during movement based on at least one of the first priority level, the first safety zone, the second priority level, or the second safety zone. In some embodiments, UAV 111 may compare the first priority level and the second priority level, and carry out the collision avoidance measure based on the comparison of the priority levels. In some embodiments, UAV 111 may compare the first priority level and the second priority level, compare the first safety zone and the second safety zone, and generate and carry out the collision avoidance measure based on the comparison of the priority levels and the comparison of safety zones. In some embodiments, UAV 111 may compare the first safety zone and the second safety zone, and generate and carry out the collision avoidance measure based on the comparison. The collision avoidance measure may include any of the measure disclosed herein, such as the vertical collision avoidance measure, the horizontal collision avoidance measure, or the collision avoidance measure performed in a three-dimensional space without separating the vertical and horizontal collision avoidance components.

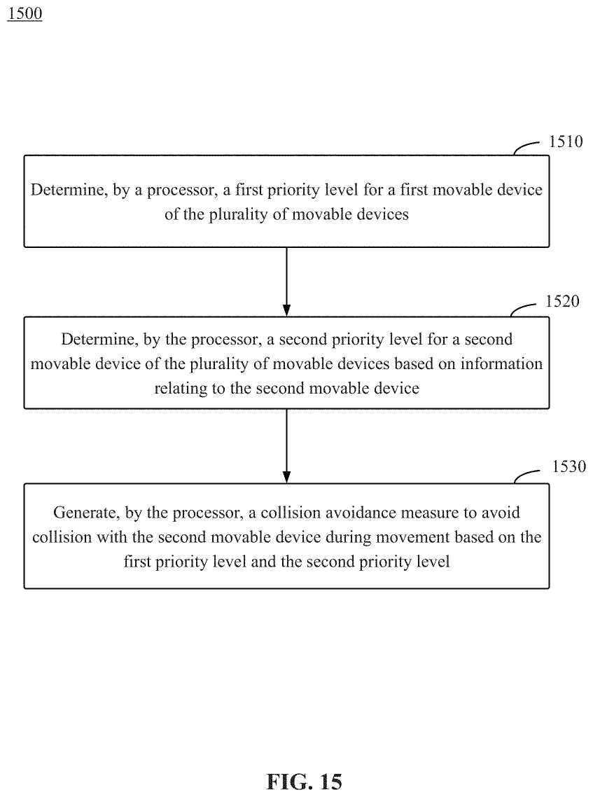

FIG. 15 is a flow chart illustrating a method 1500 for controlling movement of movable devices. Method 1500 may be performed by any individual UAV included in the system 100 or 200. For example, method 1500 may be performed by the flight control device 320 included in each UAV. Method 1500 may include determining, by a processor, a first priority level for a first movable device of the plurality of movable devices (step 1510). For example, a processor included in UAV 111 may determine a first priority level for itself based on certain information of itself, including at least one of a location, a flight speed, a flight height, a flight direction, an attitude, a task, a quality of signal, an identification, a type of UAV, or a time when a connection is first established with a remote control device, as discussed above in connection with step 1410.

Method 1500 may also include determining, by the processor, a second priority level for a second movable device of the plurality of movable devices based on information relating to the second movable device (step 1520). For example, the processor included in UAV 111 may determine a second priority level for UAV 112 based on information relating to UAV 112, including at least one of a location, a flight speed, a flight height, a flight direction, an attitude, a task, a quality of signal, an identification, a type of UAV, or a time when a connection is first established with a remote control device, as discussed above in connection with step 1420.

Method 1500 may further include generating, by the processor, a collision avoidance measure to avoid collision with the second movable device during movement based on the first priority level and the second priority level (step 1530). For example, the processor included in UAV 111 may generate and carry out any of the disclosed collision avoidance measure based on a comparison of the first priority level and the second priority level. For example, if the first priority level is higher than the second priority level, UAV 111 may proceed along its travel path without reducing its speed, or may reduce its speed at a rate lower than a rate at which the speed of UAV 112 is reduced. If the first priority level is smaller than the second priority level, UAV 111 may autonomously take any of the disclosed collision avoidance measures such that UAV 112 may pass a potential crossing point of the travel paths, if any, before UAV 111.

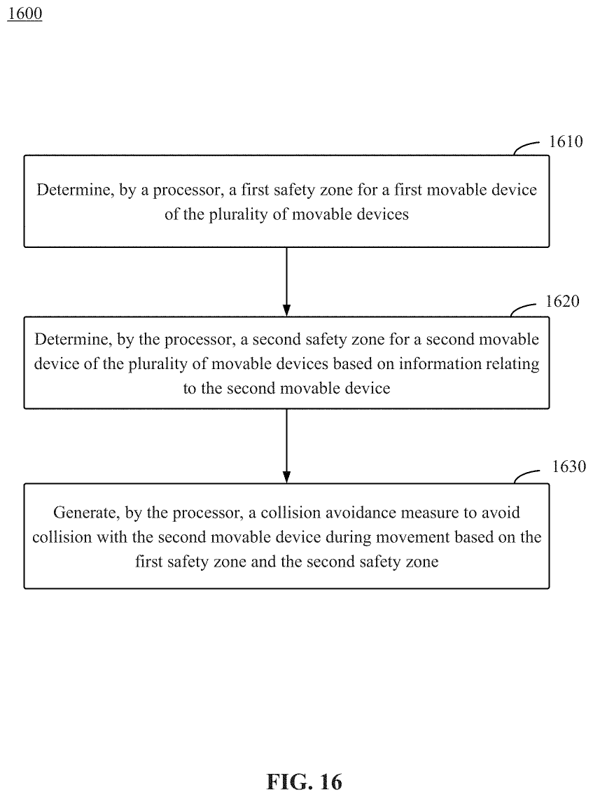

FIG. 16 is a flow chart illustrating a method 1600 for controlling movement of movable devices. Method 1600 may be performed by any individual UAV included in the system 100 or 200. For example, method 1600 may be performed by the flight control device 320 included in each UAV. Method 1600 may include determining, by a processor, a first safety zone for a first movable device of the plurality of movable devices (step 1610). For example, a processor included in UAV 111 may determine a first safety zone for itself based on certain information of itself, including at least one of a location, a flight speed, a flight height, a flight direction, an attitude, a task, a quality of signal, an identification, a type of UAV, or a time when a connection is first established with a remote control device.

Method 1600 may also include determining, by the processor, a second safety zone for a second movable device of the plurality of movable devices based on information relating to the second movable device (step 1620). For example, the processor included in UAV 111 may determine a second safety zone for UAV 112 based on information shared by UAV 112, including at least one of a location, a flight speed, a flight height, a flight direction, an attitude, a task, a quality of signal, an identification, a type of UAV, or a time when a connection is first established with a remote control device.

Method 1600 may further include generating, by the processor, a collision avoidance measure to avoid collision with the second movable device during movement based on the first safety zone and the second safety zone (step 1630). For example, based on a comparison of the first safety zone and the second safety zone, the processor included in UAV 111 may generate and carry out any of the disclosed collision avoidance measures. For example, when the first safety zone is smaller than the second safety zone, UAV 111 may reduce its speed when moving toward a potential crossing point of the travel paths, such that UAV 112 may pass by the crossing point before UAV 111.

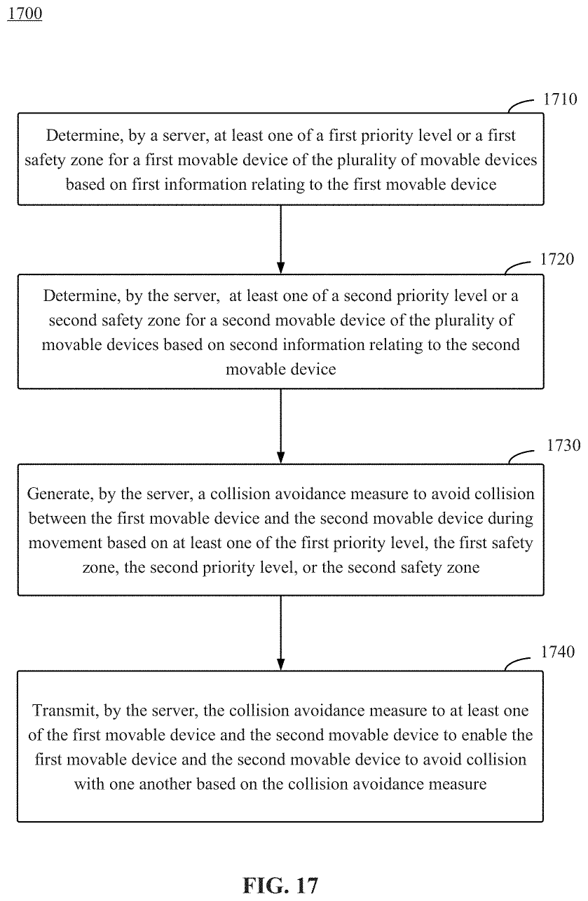

FIG. 17 is a flow chart illustrating a method 1700 for controlling movement of movable devices. Method 1700 may be performed by the server 210 included in the system 200, as shown in FIG. 2 and FIG. 5. Method 1700 may include determining, by a server, at least one of a first priority level or a first safety zone for a first movable device of the plurality of movable devices based on first information relating to the first movable device (step 1710). For example, the server 210 may receive, through transceiver 530, first information shared by some or all of the UAVs included in the system 200. The information shared by a UAV may include at least one of a location, a flight speed, a flight height, a flight direction, an attitude, a task, a quality of signal, an identification, a type of UAV, or a time when a connection is first established with a remote control device. The server 210 may determine, by processor 520, the priority levels and/or the safety zones for a UAV based on the information shared by the UAV, including at least one of a location, a flight speed, a flight height, a flight direction, an attitude, a task, a quality of signal, an identification, a type of UAV, or a time when a connection is first established with a remote control device. The server 210 may determine a first priority level and/or a first safety zone for a first UAV based on first information relating to the first UAV.

The server 210 may transmit the calculated priority levels and/or safety zones back to the UAVs that have shared information with the server 210. In some embodiments, the server 210 may transmit data relating to the priority levels and the safety zones of all of the UAVs that have shared information with the server 210 to each UAV. In some embodiments, the server 210 may determine, based on a location of a particular UAV (e.g., UAV 111), which other UAVs are located within a predetermined distance from the UAV (e.g., UAV 111), and may transmit data relating to the priority levels and/or safety zones of the UAVs (including UAV 111) that are located within the predetermined distance to the UAV (e.g., UAV 111). In such a manner, the computation of the priority levels and/or the safety zones may be performed by server 210. Each UAV may have data relating to the priority levels and/or safety zones of all of the other UAVs that shared information with the server 210, or only the UAVs that are located within a predetermined distance from the UAV.

For example, the server 210 may receive first information relating to the first UAV 111, as shared by the first UAV 111, and may determine a first priority level for the first UAV 111 based on the first information relating to first UAV 111. The first information relating to the first UAV 111 may include at least one of a location, a flight speed, a flight height, a flight direction, an attitude, a task, a quality of signal, an identification, a type of UAV, or a time when a connection is first established with a remote control device. The server 210 may determine a first safety zone for the first UAV 111. In some embodiments, the server 210 may determine the first safety zone based on the first priority level. In some embodiments, the server 210 may determine the first safety zone directly based on the information relating to the first UAV 111.

Method 1700 may also include determining, by the server, at least one of a second priority level or a second safety zone for a second movable device of the plurality of movable devices based on second information relating to the second movable device (step 1720). For example, the server 210 may receive second information shared by UAV 112. The second information may include at least one of a location, a flight speed, a flight height, a flight direction, an attitude, a task, a quality of signal, an identification, a type of UAV, or a time when a connection is first established with a remote control device. The server 210 may determine a second priority level and/or a second safety zone for the UAV 112 based on the second information relating to the UAV 112. In some embodiments, the server 210 may determine the second priority level based on the second information. In some embodiments, the server 210 may determine the second safety zone based on the second priority level. In some embodiments, the server 210 may compare the first priority level of the UAV 111 and the second priority level of the UAV 112, and determine the second safety zone of the UAV 112 based on the first safety zone of the UAV 111 and the difference between the first priority level and the second priority level. In some embodiments, for the UAV 111, the server 210 may perform similar computations for all of the other UAVs, such that the priority levels and/or the safety zones of the other UAVs may be provided to the UAV 111. The UAV 111 may carry out a collision avoidance measure based on the priority levels and/or the safety zones of the other UAVs, as well as the first priority level and the first safety zone of the UAV 111.

Method 1700 may further include generating, by the server, a collision avoidance measure to avoid collision between the first movable device and the second movable device during movement based on at least one of the first priority level, the first safety zone, the second priority level, or the second safety zone (step 1730). For example, the server 210 may generate a collision avoidance measure based on at least one of the first priority level calculated for the UAV 111, the second priority level calculated for the UAV 112, the first safety zone calculated for the UAV 111, or the second safety zone calculated for the UAV 112. In some embodiments, the server 210 may generate the collision avoidance measure based on a comparison between the first priority level and the second priority level. In some embodiments, the server 210 may generate the collision avoidance measure based on a comparison between the first safety zone and the second safety zone. In some embodiments, the server 210 may generate the collision avoidance measure based on both comparisons between the first priority level and the second priority level, and between the first safety zone and the second safety zone.

Method 1700 may include transmitting, by the server, the collision avoidance measure to at least one of the first movable device and the second movable device to enable the first movable device and the second movable device to avoid collision with one another based on the collision avoidance measure (step 1740). In some embodiments, the server 210 may transmit the collision avoidance measure to the remote control devices, which may further relay the collision avoidance measure to the UAVs connected with the remote control devices. The UAV 111 and the UAV 112 may each carry out a portion of the collision avoidance measure, if needed, based on at least one of the first priority level, the second priority level, the first safety zone, or the second safety zone. In some embodiments, the server 210 may compare the priority level of UAV 111 (an example of each UAV) with priority levels of a plurality of other neighboring UAVs (e.g., those located within a predetermined distance from UAV 111), and determine, with respect to which other UAVs, that UAV 111 needs to take a collision avoidance measure. The server 210 may develop a collision avoidance measure and send instructions relating to the collision avoidance measure to UAV 111 such that UAV 111 may carry out the collision avoidance measure with respect to the neighboring UAVs. In other words, in some embodiments, the server 210 may perform all of the computation, and send flight control signals or instructions to UAV 111 for carrying out the collision avoidance measure.

For example, the UAV 111 may compare the first priority level with the second priority level. The first and second priority levels may not be the same. If the first priority level is greater than the second priority level, the UAV 111 may proceed to travel along its travel path without reducing its speed. If the first priority level is smaller than the second priority level, the UAV 111 may carry out a collision avoidance measure, such as by reducing its speed, to avoid collision with the UAV 112. As another example, the UAV 111 may compare a size of the first safety zone with a size of the second safety zone. In some embodiments, if the size of the first safety zone is greater than the size of the second safety zone, the UAV 111 may proceed to travel along its travel path without reducing its speed. If the first safety zone is smaller than the second safety zone, the UAV 111 may carry out a collision avoidance measure, such as by reducing its speed, to avoid collision with the UAV 112.

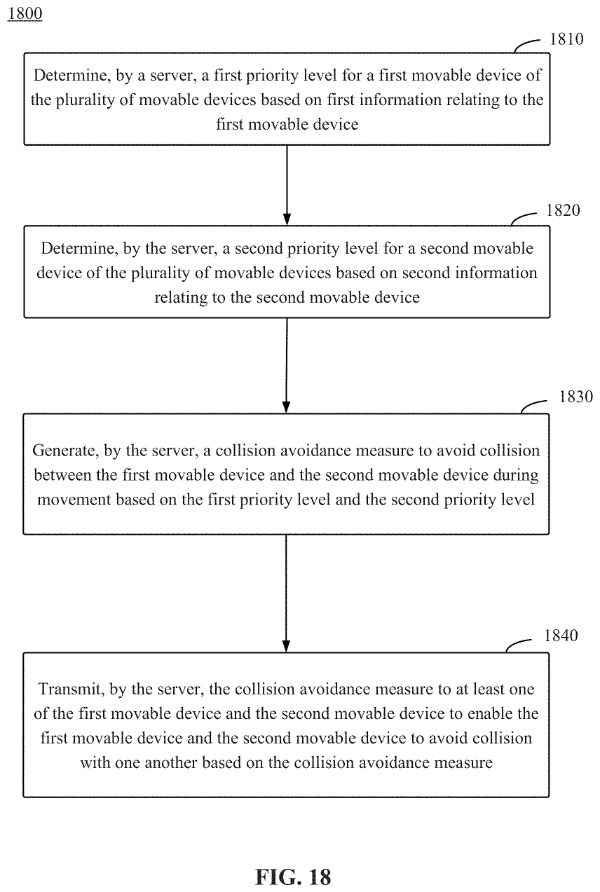

FIG. 18 is a flow chart illustrating a method 1800 for controlling movement of movable devices. Method 1800 may be performed by the server 210 included in the system 200, as shown in FIG. 2 and FIG. 5. Method 1800 may include determining, by a server, a first priority level for a first movable device of the plurality of movable devices based on first information relating to the first movable device (step 1810). For example, the server 210 may determine a first priority level for UAV 111 based on first information received from the UAV 111. The first information shared by UAV 111 may include at least one of a location, a flight speed, a flight height, a flight direction, an attitude, a task, a quality of signal, an identification, a type of UAV, or a time when a connection is first established with a remote control device.

Method 1800 may also include determining, by the server, a second priority level for a second movable device of the plurality of movable devices based on second information relating to the second movable device (step 1820). For example, the server 210 may determine a second priority level for UAV 112 based on second information received from the UAV 112. The second information shared by the UAV 112 may include at least one of a location, a flight speed, a flight height, a flight direction, an attitude, a task, a quality of signal, an identification, a type of UAV, or a time when a connection is first established with a remote control device.

Method 1800 may include generating, by the server, a collision avoidance measure to avoid collision between the first movable device and the second movable device during movement based on the first priority level and the second priority level (step 1830). For example, the server 210 may generate a collision avoidance measure based on the first priority level of UAV 111 and the second priority level of UAV 112. The server 210 may compare the first priority level and the second priority level. If the first priority level is greater than the second priority level, the collision avoidance measure may instruct the UAV 111 to take actions to avoid collision with the UAV 112, such as by reducing the speed of the UAV 111.

Method 1800 may further transmitting, by the server, the collision avoidance measure to at least one of the first movable device and the second movable device to enable the first movable device and the second movable device to avoid collision with one another based on the collision avoidance measure (step 1840). For example, the server 210 may transmit the collision avoidance measure to at least one of the UAV 111 or the UAV 112. In some embodiments, the server 210 may transmit the collision avoidance measure to the remote control devices, which may further relay the data to the UAVs connected with the remote control devices. In some embodiments, the server 210 may transmit the collision avoidance measure to each of the UAV 111 and the UAV 112.

The collision avoidance measure may include instructions for both of the UAV 111 and the UAV 112 to take actions (e.g., reducing speeds at different rates) to avoid collision. Each of the UAV 111 and the UAV 112 may carry out a collision avoidance measure to avoid collision with one another based on at least the collision avoidance measure from the server 210. In some embodiments, the server 210 may compare the first priority level with the second priority level. If the first priority level is smaller than the second priority level, the server 210 may instruct the UAV 111 to carry out a collision avoidance measure to avoid collision with the UAV 112, for example, by reducing the speed of the UAV 111. In some embodiments, if the first priority level is greater than the second priority level, the server 210 may instruct the UAV 111 to continue to travel along its travel path without reducing its speed.

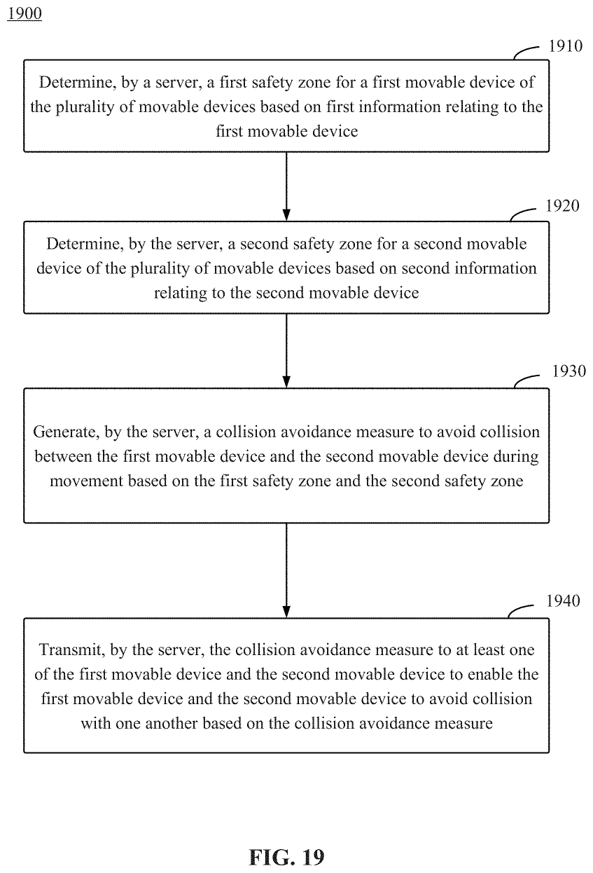

FIG. 19 is a flow chart illustrating a method 1900 for controlling movement of movable devices. Method 1900 may be performed by the server 210 included in the system 200, as shown in FIG. 2 and FIG. 5. Method 1900 may include determining, by a server, a first safety zone for a first movable device of the plurality of movable devices based on first information relating to the first movable device (step 1910). For example, the server 210 may determine a first safety zone for the UAV 111 based on first information received from the UAV 111. The first information shared by the UAV 111 may include at least one of a location, a flight speed, a flight height, a flight direction, an attitude, a task, a quality of signal, an identification, a type of UAV, or a time when a connection is first established with a remote control device.

Method 1900 may also include determining, by the server, a second safety zone for a second movable device of the plurality of movable devices based on second information relating to the second movable device (step 1920). For example, the server 210 may determine a second safety zone for the UAV 112 based on second information received from the UAV 112. The second information shared by the UAV 112 may include at least one of a location, a flight speed, a flight height, a flight direction, an attitude, a task, a quality of signal, an identification, a type of UAV, or a time when a connection is first established with a remote control device.

Method 1900 may include generating, by the server, a collision avoidance measure to avoid collision between the first movable device and the second movable device during movement based on the first safety zone and the second safety zone (step 1930). For example, based on a comparison of the sizes of the first safety zone and the second safety zone, the server 210 may determine a collision avoidance measure to avoid collision between the UAV 111 and the UAV 112. For example, if the first safety zone of the UAV 111 is smaller than the second safety zone of the UAV 112, the server 210 may determine a collision avoidance measure that instructs the UAV 111 to take actions to avoid collision with the UAV 112, including, for example, reducing the speed of the UAV 111.

Method 1900 may further include transmitting, by the server, the collision avoidance measure to at least one of the first movable device and the second movable device to enable the first movable device and the second movable device to avoid collision with one another based on the collision avoidance measure (step 1940). For example, the server 210 may transmit the collision avoidance measure to at least one of the first movable device or the second movable device. In some embodiments, the server 210 may transmit the collision avoidance measure to the remote control devices, which may further relay the collision avoidance measure to the UAVs. In some embodiments, the server 210 may transmit the collision avoidance measure to each of the UAV 111 and the UAV 112. Each of the UAV 111 and the UAV 112 may carry out a portion of the collision avoidance measure to avoid collision with one another based on at least the data from the server 210. For example, the UAV 111 may compare the first safety zone with the second safety zone. If the first safety zone is smaller than the second safety zone, the UAV 111 may carry out a collision avoidance measure to avoid collision with the UAV 112, for example, by reducing the speed of the UAV 111. In some embodiments, if the first safety zone is greater than the second safety zone, the UAV 111 may continue to travel along its travel path without reducing its speed.

The disclosed methods may include other steps or processes. For example, in some embodiments, some of the determination, calculation, or computation performed by any UAV may be performed by a remote control device. For example, a remote control device may determine priority levels and/or safety zones for some or all of the UAVs controlled by the remote control device, based on information shared by the UAVs. In some embodiments, the remote control device may share the calculated priority levels and/or safety zones with some or all of UAVs controlled by the remote control device. In some embodiments, the remote control device may share the calculated priority levels and/or safety zones with some UAVs controlled by another remote control device by sending data relating to the calculated priority levels and/or safety zones to the other remote control device.

In some embodiments, some of the determination, calculation, or computation performed by the server 210 may be performed by a remote control device. In some embodiments, the computation of the priority levels and/or safety zones for the UAVs may be distributed to one or more UAVs, one or more remote control devices, and/or the server 210. The distribution of the computation may be based on real time monitoring of the computing capabilities of the UAVs, remote control devices, and/or server, the signal strengths relating to communication, the delay in communication, etc.

While embodiments of the present disclosure have been shown and described herein, it will be obvious to those skilled in the art that such embodiments are provided by way of example only. Numerous variations, changes, and substitutions will now occur to those skilled in the art without departing from the present disclosure. It should be understood that various alternatives to the embodiments of the invention described herein may be employed in practicing the present disclosure. It is intended that the following claims define the scope of the invention and that methods and structures within the scope of these claims and their equivalents be covered thereby.

What is claimed is:

1. A method of controlling movement of a plurality of movable devices, comprising:
determining, by a processor, at least one of a first priority level or a first safety zone for a first movable device of the plurality of movable devices;
determining, by the processor, at least one of a second priority level or a second safety zone for a second movable device of the plurality of movable devices based on information relating to the second movable device; and
generating, by the processor, a collision avoidance measure to avoid collision with the second movable device during movement based on at least one of the first priority level, the first safety zone, the second priority level, or the second safety zone.

2. The method of claim 1, further comprising:
receiving the information relating to the second movable device.

3. The method of claim 2, wherein the information relating to the second movable device comprises at least one of a location, a flight height, a flight speed, a flight direction, attitude, a task, a quality of signal, an identification, a type of the second movable device, or a time when a connection is established with a remote control device.

4. The method of claim 2, wherein receiving the information relating to the second movable device comprises receiving the information relating to the second movable device when the second movable device is located within a predetermined distance from the first movable device.

5. The method of claim 2, wherein receiving the information relating to the second movable device comprises receiving the information from at least one of a remote control device or a communication base station.

6. The method of claim 1,
wherein determining the at least one of the first priority level or the first safety zone comprises determining the first priority level and the first safety zone,
wherein determining the at least one of the second priority level or the second safety zone comprises determining the second priority level and the second safety zone, and
wherein generating the collision avoidance measure comprises generating the collision avoidance measure based on the first priority level, the second priority level, the first safety zone, and the second safety zone.

7. The method of claim 6,
wherein determining the first safety zone comprises determining the first safety zone based on the first priority level, and determining the second safety zone comprises determining the second safety zone based on the second priority level.

8. The method of claim 1,
wherein the first safety zone has a first cylindrical shape, and the first movable device is located at a center of the first cylindrical shape, and
wherein the second safety zone has a second cylindrical shape, and the second movable device is located at a center of the second cylindrical shape.

9. The method of claim 1,
wherein the first safety zone has a first spherical shape, and the first movable device is located at a center of the first spherical shape, and
wherein the second safety zone has a second spherical shape, and the second movable device is located at a center of the second spherical shape.

10. The method of claim 1, wherein the first safety zone and the second safety zone have different shapes.

11. The method of claim 1, wherein a size of a vertical plane projection of each of the first safety zone and the second safety zone is determined based on a precision of a corresponding positioning system that provides location information of each of the first movable device and the second movable device.

12. The method of claim 1, wherein a size of a horizontal plane projection of each of the first safety zone and the second safety zone is determined based on each of the corresponding first priority level and the second priority level.

13. The method of claim 1, further comprising:
carrying out the collision avoidance measure, wherein carrying out the collision avoidance measure comprises carrying out a vertical collision avoidance measure, wherein the vertical collision avoidance measure comprises:
based on a determination that horizontal plane projections of the first movable device and the second movable device are adjacent to one another, and a determination that the first priority level is smaller than the second priority level, reducing a vertical speed of the first movable device.

14. The method of claim 13, wherein the determination that the horizontal plane projections of the first movable device and the second movable device are adjacent to one another comprises a determination that a first horizontal plane projection of the first safety zone of the first movable device overlaps with a second horizontal plane projection of the second safety zone of the second movable device.

15. The method of claim 13, wherein the determination that the horizontal plane projections of the first movable device and the second movable device are adjacent to one another comprises a determination that a horizontal plane projection of the second movable device is within a horizontal plane projection of the first safety zone of the first movable device.

16. The method of claim 13, wherein reducing the vertical speed of the first movable device is performed while the first priority level is greater than the second priority level.

17. The method of claim 13, wherein reducing the vertical speed of the first movable device is based on a distance that is determined to be a smaller one of a first distance between the second movable device and a vertical edge of a vertical plane projection of the first safety zone, and a second distance between the first movable device and a vertical edge of a vertical plane projection of the second safety zone.

18. The method of claim 17, wherein reducing the vertical speed of the first movable device comprises reducing the vertical speed until about zero when the distance is reduced to about zero.

19. A method of controlling movement of a plurality of movable devices, comprising:
determining, by a server, at least one of a first priority level or a first safety zone for a first movable device of the plurality of movable devices based on first information relating to the first movable device;
determining, by the server, at least one of a second priority level or a second safety zone for a second movable device of the plurality of movable devices based on second information relating to the second movable device;
generating, by the server, a collision avoidance measure to avoid collision between the first movable device and the second movable device during movement based on at least one of the first priority level, the first safety zone, the second priority level, or the second safety zone; and
transmitting, by the server, the collision avoidance measure to at least one of the first movable device or the second movable device to enable the at least one of the first movable device or the second movable device to avoid collision with one another based on the collision avoidance measure.

20. A system, comprising:
a plurality of movable devices movable in an environment,
wherein a first movable device of the plurality of movable devices comprises a memory configured to store instructions and a processor configured to access the memory and execute the instructions to:
determine at least one of a first priority level or a first safety zone for the first movable device of the plurality of movable devices;
determine at least one of a second priority level or a second safety zone for a second movable device of the plurality of movable devices based on information relating to the second movable device; and
generate a collision avoidance measure to avoid collision with the second movable device during movement based on at least one of the first priority level, the first safety zone, the second priority level, or the second safety zone.
